(19) United States
(12) Patent Application Publication
(10) Pub. No.: US 2011/0264594 A1
(43) Pub. Date: Oct. 27, 2011

(54) SYSTEM AND METHOD FOR MANAGING PRODUCT INFORMATION

(75) Inventor: Ramesh Babu Govindaraju, Singapore (SG)

(73) Assignee: YARRAA PTE LTD, Singapore (SG)

(21) Appl. No.: 13/124,542

(22) PCT Filed: Oct. 15, 2009
(86) PCT No.: PCT/SG2009/000378

§ 371 Date: Jul. 11, 2011

(30) Foreign Application Priority Data
Oct. 15, 2008 (SG) 200807700-0

(51) Int. Cl. G06F 17/30; G06Q 99/00

(52) U.S. Cl. 705/302

(57) ABSTRACT

A system and method for managing product information is disclosed. The system comprising: a portal comprising an information processing system, the information processing system comprising a data base for storing one or more product information of a brand including identification information of one or more products of the brand, the product and identification information are entered by a first user having a first authentication information obtained by registering into the portal, wherein the stored product information is accessible by one or more other users having respective authentication information obtained after registering with the portal for a product of the same brand, wherein database for storing the one or more product information is accessible remotely by the one or more other users under an authorization control of the portal.

### FIELD OF THE INVENTION

The present invention relates broadly to a system and method for managing product information.

### BACKGROUND

Product return is an everyday occurrence for manufacturers (including OEM/ODM), distributors, service centers, retailers, consumers, logistics providers, recycling centers, and insurance providers. Product return may occur due to defective merchandise, ill-suited gifts, legally mandated recycling, or unsold merchandise etc. Most manufacturers (including original equipment manufacturers (OEM)/original design manufacturers (ODM)), distributors, service centers, retailers, end users/consumers, and recyclers have no protocol in place for managing product returns. Some utilize customized trial and error methods, which may be unreliable, inefficient and expensive. Furthermore, customized methods do not link all the points of the product cycle, including manufacturers (including OEM/ODM), distributors, retailers, service centers, recycling centers, insurance providers, logistics providers and end users/consumers.

It is difficult for end users/consumers to know the status of a product which was returned for service. Furthermore, end users/consumers are often left out of the sphere of communication once they have paid for their purchases from different retailers, distributors, websites or manufacturers (including OEM/ODM). End users/consumers are usually not aware of the terms, conditions, and warranty details of every product they own. Every household has a collection of diverse products purchased from various companies on various dates. Keeping track of the warranty information for all the products can be a daunting task. Even if a consumer is aware of the warranty details, it may not be practical to know where and how to send a product for repair or replacement. Because of such difficulties, a consumer may choose not to pursue a valid warranty claim.

Managing reverse logistics is, therefore, an important part of the sales process of any product. Some companies that manufacture consumer products have websites to register the details of products. It is usually tedious for end users/consumers to access the websites of different companies to register for each product. Some companies do not have a website for registering warranty information, and may instead require a consumer to post a warranty card to a designated postal address. A warranty card can be misplaced or discarded by the consumer, or it may not reach the designated address.

Different problems arise for a retailer who sells products of many brands. In case of a wrong delivery, a retailer may need to send back a product to another retailer, distributor, manufacturer (including OEM/ODM), or a service center, which requires the retailer to systematically update the addresses of the respective parties. Otherwise, it may trigger unnecessary expense to the retailer. Furthermore, it is also tedious for the retailer to track the details of incoming, outgoing or outstanding products returned by customers.

Retailers may not have the capacity to track the origin of products or accessories, which in turn makes it difficult to identify the place of origin of defective products or accessories. Furthermore, retailers must follow different documentation procedures for each distributor or manufacturer (including OEM/ODM) while receiving or returning products. For example, a product may have to be returned to an overseas vendor, which requires different documentation procedures when compared to returning products domestically. Sometimes, a retailer may not know whether the warranty registration of a product is through a website or a warranty card that needs to be physically posted.

A distributor, dealing with many brands, may find it cumbersome to track the details of incoming, outgoing and outstanding products from different manufacturers (including OEM/ODM), service centers, retailers or end users/consumers. Furthermore, a distributor may need to follow different documentation procedures while receiving or returning products from different manufacturers (including OEM/ODM), service centers or retailers.

Lack of proper communication among manufacturers (including OEM/ODM), distributors, service centers, retailers and logistics providers is another problem that slows down the product returns process.

In addition, lack of information, such as reasons for return of a product (e.g. repair, replacement, physical damage, expiry of warranty, unsold merchandise etc.) can cause inefficiency in a reverse logistics system. Even if a clear line of communication exists between manufacturers (including OEM/ODM), distributors, service centers, retailers and logistics providers, it may not be cost effective to ship lower quantities of products.

Recently, attempts have been made to streamline reverse logistics problems encountered by manufacturers (including OEM/ODM), distributors, retailers, service centers and end users/consumers.

Some of the presently used reverse logistics systems employ trial and error methods that may not work consistently amongst all manufacturers (including OEM/ODM), distributors, retailers, service centers, recyclers and end users/consumers. Other reverse logistics systems establish one-on-one communication between any two of the manufacturers (including OEM/ODM), distributors, retailers, service centers, recyclers and end users/consumers. (i.e. between one retailer and one service center or a manufacturer (including OEM/ODM) and distributor). Even so, each of the parties that are in mutual communication must have its own database to manage the reverse logistics process.

Furthermore, a distributor, retailer or service center deals with a large number of products of various manufacturers (including OEM/ODM). Each manufacturer (including OEM/ODM) may use different operating systems, different databases, different IT infrastructures, and different processes to deal with reverse logistics. It is impractical and expensive for a distributor, retailer or service center to use logistics systems from the respective manufacturers (including OEM/ODM) of the products under different logins.

Accordingly, there is a need to provide a reverse logistics system and method, which seeks to address one or more of the above problems.

### SUMMARY OF THE INVENTION

According to a first aspect, there is provided a system for managing product information of one or more brands comprising:
a portal comprising an information processing system, the information processing system comprising a data base for storing one or more product information of a brand including identification information of one or more products of the brand, the product and identification information are entered by a first user having a first authentication information obtained by registering into the portal,
wherein the stored product information is accessible by one or more other users having respective authentication information obtained after registering with the portal for a product of the same brand,
whereby the database for storing the one or more product information is accessible remotely by the first and the one or more other users under an authorization control of the portal.

The product information may include one or more of a brand name, model name, model number, date of manufacture, place of manufacture or warranty details.

The identification information may include one or more of a serial number, stock keeping unit (SKU) number, International Mobile Equipment Identity (IMEI) number, Universal Product Code (UPC), Electronics Product Code (EPC), European Article Number (EAN), European Article Number (EAN) or other manufacturing identification number.

The users of the portal may include manufacturers (including OEM/ODM), distributors, service centers, retailers, consumers/end users, recyclers, logistics providers and insurance providers.

A plurality of authentication information may be allocated by the portal to a manufacturer, distributor, service center or retailer for accessing information of one or more brands.

One of more of plurality of the allocated authentication information obtained by a manufacturer, distributor, service center or retailer may be donated to other manufacturer, distributor, service center or retailer. The authentication information may include a unique user ID and password.

When a manufacturer (including OEM/ODM) of one brand registers into the portal, information for each product and/or brand may be uploaded, entered, altered or routed in to the database, which may shared by one or more of distributors, service centers, retailers or consumers/end users that have registered with the portal for the same product and brand.

When a distributor of one brand registers into the portal, information for each product and/or brand may be uploaded, entered, altered or routed in to the database, which may be shared by one or more manufacturers (including OEM/ODM), service centers, retailers or consumers/end users that have registered with the portal for the same product and brand.

When a service center of one brand registers into the portal, information for each product and/or brand may be uploaded, entered, altered or routed in to the database, which may be shared by one or more manufacturers (including OEM/ODM), distributors, retailers or consumers/end users that have registered with the portal for the same product and brand.

When a retailer of one brand registers into the portal, information for each product and/or brand may be uploaded, entered, altered or routed in to the database, which may be shared by one or more manufacturers (including OEM/ODM), distributors, service centers or consumers/end users that have registered with the portal for the same product and brand.

When a consumer/end user of one brand registers into the portal, information for each product and/or brand may be uploaded, entered, altered or routed in to the database, which may be shared by one or more manufacturers (including OEM/ODM), distributors, service centers or retailers that have registered with the portal for the same product and brand.

When a recycler registers into the portal, information for any and all products and brands may be routed to the recycler's account by other users that have registered with the portal, and who wish to dispose of their products responsibly.

When a logistics provider registers into the portal, information for any and all products and brands may be routed to the logistics provider's account by other users that have registered with the portal, and who require shipping services for their after-purchase needs.

When an insurance provider registers into the portal, information for any and all products and brands may be routed to the insurance provider's account by other users that have registered with the portal, and who wish to purchase insurance coverage for their products.

Wherein a registered manufacturer (including OEM/ODM), distributor, service center or retailer may obtain one or more region-wise, country-wise, distributor-wise, service center-wise, retailer-wise, product-wise, model-wise or customer-wise information about the failure rate, inventory status, failure details or return rates based on the previously uploaded, entered, updated or routed information of the various products handled by other registered users of the portal.

A registered user of the portal may obtain one or more of respective warranty details, repair history, authorized and other service centers, authorized retailers or promotions related to the brand of products.

A registered user of the portal may use the portal to extend the warranty, obtain information on when to send and receive a product for repair, receive and approve the quotations from service centers, provide feedback about repairs, or place a request to send a repaired product by a courier.

A registered user of the portal may use the portal to contact consumers/end users of its products via targeted e-mail and SMS services, using purchase- and contact-information contained in the portal.

The portal may be used to track inflow and outflow in reverse logistics among the registered manufacturers, distributors, service centers, retailers and/or end users/consumers. The registered end users/consumers may use the portal to track asset value and warranty services of their products.

When a manufacturer (including OEM/ODM) of one brand has not registered with the portal, one or more of the distributors, service centers, retailers or consumers/end users that have registered with the portal for the same product may operate in a standalone mode, wherein information specific to the products handled by the respective distributors, service centers, retailers or consumers/end users may be shared.

The information shared in standalone mode may include warranty details or repair history related to the specific products handled by the respective distributors, service centers, retailers or consumers.

According to a second aspect, there is provided a method for managing product information of one or more brands comprising the steps of:
accessing, by a first user, a portal having a database;
registering and obtaining, by the first user, a first authentication information from the portal;
using the first authentication information to login to the portal;
entering one or more product information including identification information of one or more products of a brand into the database of the portal; and
accessing the stored product information, by one or more other users having respective authentication information obtained after registering with the portal for a product of the same brand,
wherein database for storing the one or more product information is accessible remotely by the one or more other users under an authorization control of the portal.

The users of the portal may include manufacturers (including OEM/ODM), distributors, service centers, retailers, consumers/end users, recyclers, logistics providers and insurance providers. The authentication information may include a unique user ID and password.

When a manufacturer (including OEM/ODM) of one brand registers into the portal, information for each product and/or brand may be uploaded, entered, altered or routed in to the database, which may be shared by one or more of distributors, service centers, retailers, consumers/end users, recyclers, logistics providers or insurance providers that have registered with the portal for the same product and brand.

When a manufacturer (including OEM/ODM) of one brand has not registered with the portal, one or more of the distributors, service centers, retailers, consumers/end users, recyclers, logistics providers and insurance providers that have registered with the portal for the same product may operate in a standalone mode, wherein information specific to the products handled by the respective distributors, service centers, retailers consumers/end users, recyclers, logistics providers or insurance providers may be shared.

When a distributor of one brand has not registered with the portal, one or more of the manufacturers (including OEM/ODM), service centers, retailers, consumers/end users, recyclers, logistics providers or insurance providers that have registered with the portal for the same product may operate in a standalone mode, wherein information specific to the products handled by the respective manufacturers (including OEM/ODM), service centers, retailers, consumers/end users, recyclers, logistics providers or insurance providers may be shared.

When a service center of one brand has not registered with the portal, one or more of the manufacturers (including OEM/ODM), distributors, retailers, consumers/end users, recyclers, logistics providers or insurance providers that have registered with the portal for the same product may operate in a standalone mode, wherein information specific to the products handled by the respective manufacturers (including OEM/ODM), distributors, retailers, consumers/end users, recyclers, logistics providers or insurance providers may be shared.

When a retailer of one brand has not registered with the portal, one or more of the manufacturers, distributors, service centers, consumers/end users, recyclers, logistics providers or insurance providers that have registered with the portal for the same product may operate in a standalone mode, wherein information specific to the products handled by the respective manufacturers (including OEM/ODM), distributors, service centers, consumers/end users, recyclers, logistics providers or insurance providers may be shared.

When a previously unregistered partner registers with the portal, the information available to existing registered partners on standalone mode may be available to the newly registered partner.

According to a third aspect, there is provided a data storage medium comprising computer code means for instructing a computer to execute a method for managing product information of one or more brands comprising the steps of:
accessing , by a first user, a portal having a database;
registering and obtaining, by the first user, a first authentication information from the portal;
using the first authentication information to login to the portal;
entering one or more product information including identification information of one or more products of a brand into the database of the portal; and
accessing the stored product information, by one or more other users having respective authentication information obtained after registering with the portal for a product of the same brand,
whereby the database for storing the one or more product information is accessible remotely by the one or more other users under an authorization control of the portal.

### BRIEF DESCRIPTION OF THE DRAWINGS

The present invention is further described by way of non-limiting embodiments, with reference to the accompanying drawings, in which:

FIG. 1a is an illustration of a prior art problem addressed by an embodiment of the present invention;

FIG. 1b is a schematic diagram of a reverse logistics system in accordance with an embodiment;

FIG. 2 is a flow chart showing a manufacturer (including OEM/ODM) using the system of FIG. 1b;

FIG. 3 is a flow chart showing a distributor using the system of FIG. 1b;

FIG. 4 is a flow chart showing a service center using the system of FIG. 1b;

FIG. 5 is a flow chart showing a retailer using the system of FIG. 1b;

FIG. 6 is a flow chart showing a recycler using the system of FIG. 1b;

FIG. 7 is a flow chart showing an end user/consumer using the system of FIG. 1b;

FIG. 8 is a flowchart detailing a registration process for the system of FIG. 1b;

FIG. 9 is a flowchart detailing a login process for the system of FIG. 1b;

FIG. 10 is a flowchart detailing a forgotten password process for the system of FIG. 1b;

FIG. 11 is a flowchart detailing a company management process for the system of FIG. 1b;

FIG. 12 is a flowchart detailing a license management process for the system of FIG. 1b.

FIG. 13 is a flowchart detailing a user management process for the system of FIG. 1b;

FIG. 14 is a flowchart detailing a return material authorization (RMA) process for the system of FIG. 1b; and

FIG. 15 shows a schematic drawing illustrating a computer system for implementing the method and system of the example embodiment.

### DETAILED DESCRIPTION OF PREFERRED EMBODIMENTS

The described example embodiment can provide a reverse logistics system, which offers a single platform that can efficiently link and manage the reverse logistics process of all manufacturers (including OEM/ODM), distributors, retailers, service centers and end users/consumers. Furthermore, the described example embodiments can provide a current reverse logistics system which offers a single platform that can identify a product and provide information through the lifecycle of the product to manufacturers (including OEM/ODM), distributors, retailers, service centers and end users/consumers.

Some portions of the description which follows are explicitly or implicitly presented in terms of algorithms and functional or symbolic representations of operations on data within a computer memory. Those data operations are processed in a server and are then transferred to the users through a network. This action can be performed on a browser or through an internet or intranet. The algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet/intranet system, or wireless medium such as exemplified in the GSM/GPRS/3G/4G mobile telephone system. The services performed by an embodiment of the present invention are processed in a server and then transferred to the user through a network; the program therefore effectively results in a computer functioning as an apparatus that implements the steps of the preferred method.

Embodiments of the present invention may also be implemented as hardware modules. More particular, in the hardwire sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

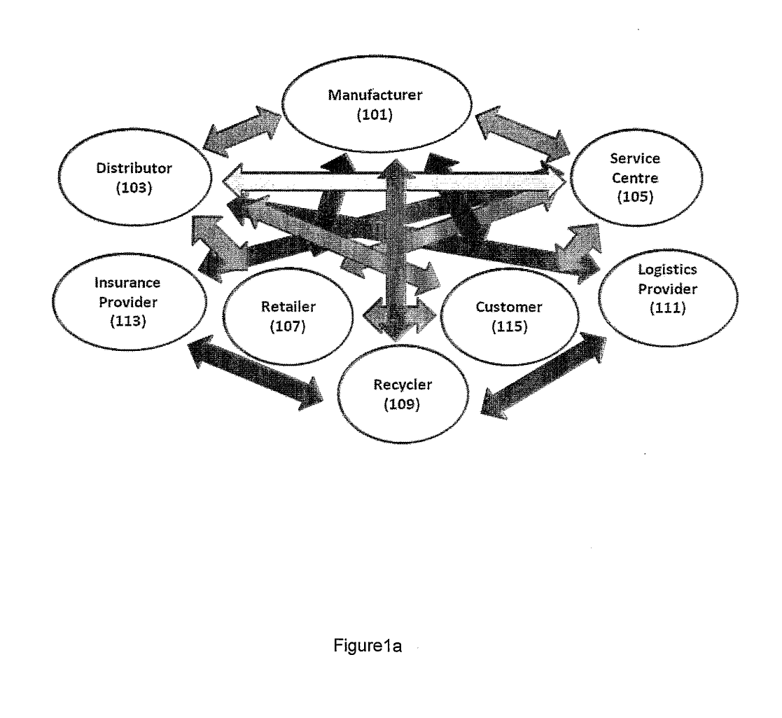

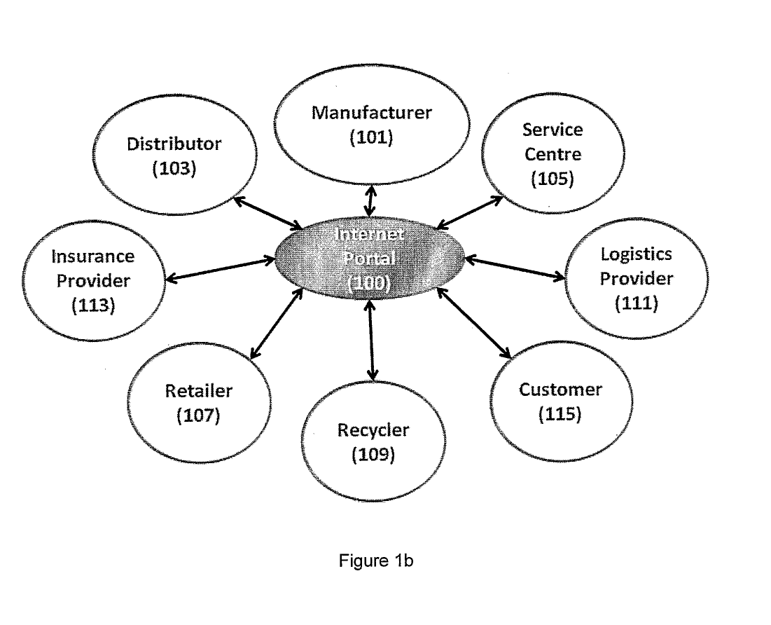

FIG. 1a is an illustration of a prior art problem addressed by an embodiment of the present invention. Without a centralized reverse logistics system, a network of remotely located manufacturers (including OEM/ODM) 101, distributors 103, service centers 105, retailers 107, recyclers 109, logistics providers 111, insurance providers 113 and end users/consumers 115 have no organized means of communication. Effective communication among three or more points in the product cycle is highly inefficient and undependable. Sharing up to date information on a given case with all concerned parties is nearly impossible.

FIG. 1b is a schematic diagram of a reverse logistics system 100 in accordance with an embodiment. A network of remotely located manufacturers (including OEM/ODM) 101, distributors 103, service centers 105, retailers 107, recyclers 109, logistics providers 111, insurance providers 113 and end users/consumers 115 are connected to a central database 100 of a portal in order to access information stored in central database 100. The central database 100 manages the portfolios of various products of different manufacturers (including OEM/ODM) 101, distributors 103, service centers 105, retailers 107, recyclers 109, logistics providers 111, insurance providers 113 and end users/consumers 115 of the portal. Any manufacturer (including OEM/ODM) 101, distributor 103, service center 105, retailer 107, recycler 109, logistics provider 111, insurance provider 113 and end user/consumer 115 who has registered and obtained a valid user ID (for example, an e-mail address) and password form the portal can be called as a partner to the portal.

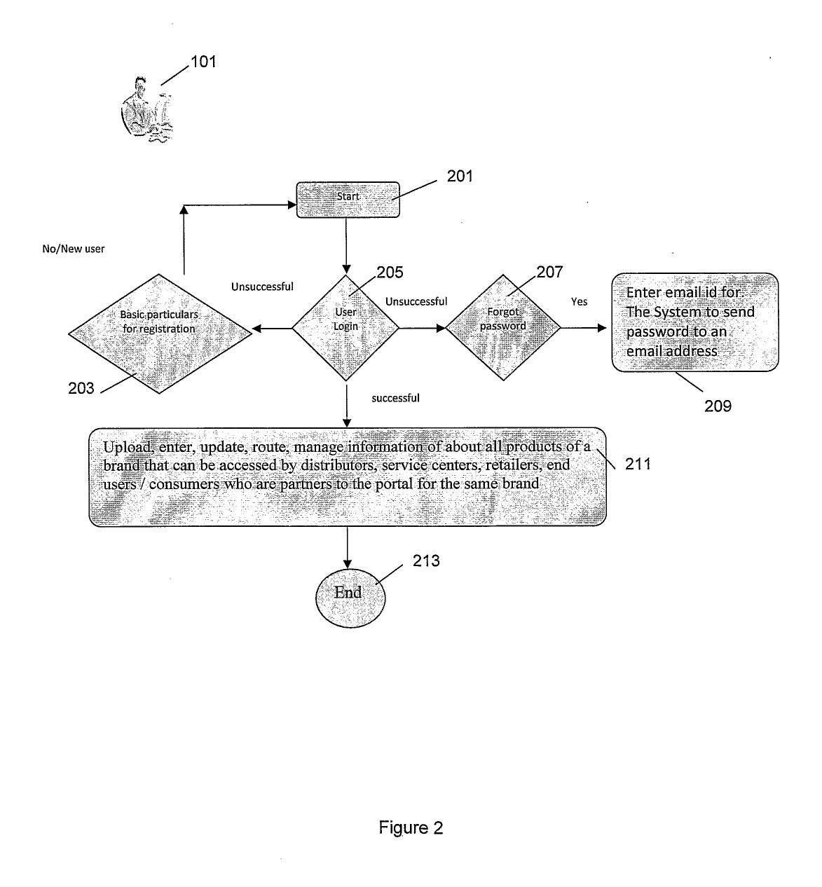

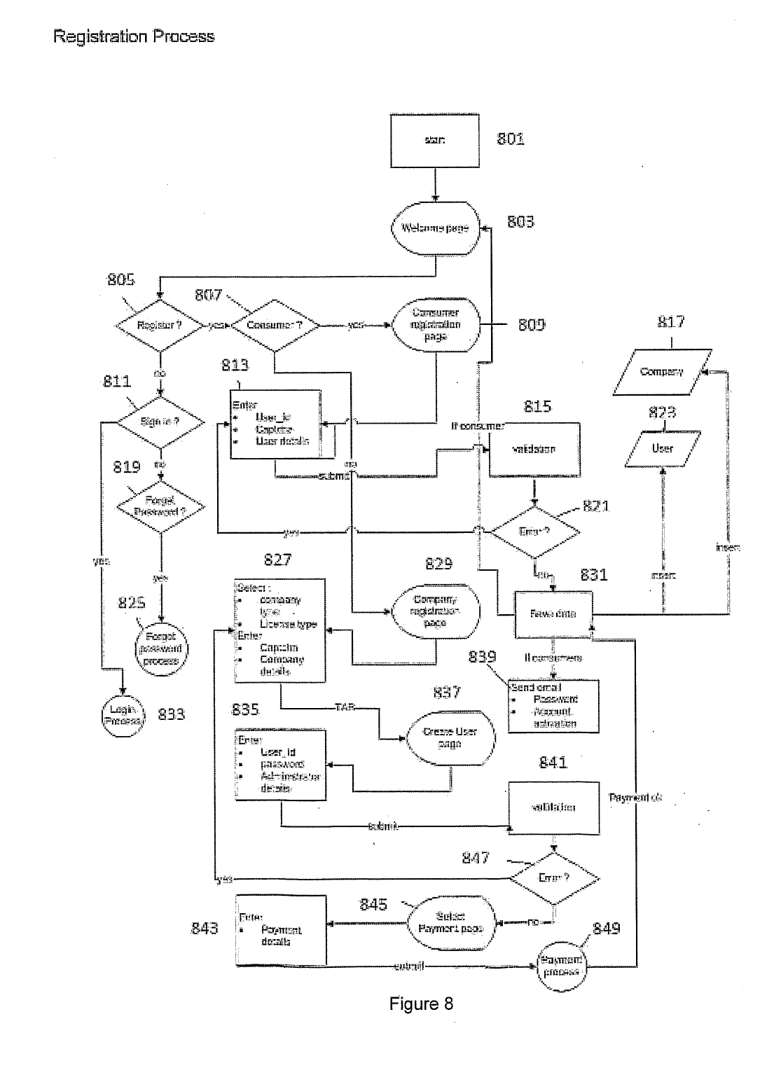

FIG. 2 is a flow chart showing a manufacturer (including OEM/ODM) 101 using the system of FIG. 1b. In case a manufacturer (including OEM/ODM) 101 wishes to become a partner to the portal, at step 201 the manufacturer (including OEM/ODM) 101 starts by accessing a portal having a domain name. The portal has provisions for new registration at step 203. (See FIG. 8 below for the details of the registration process.) Subject to completing the registration formalities and license conditions, at least one user ID and password are allocated to the manufacturer (including OEM/ODM) 101.

Furthermore, depending on terms and conditions, a manufacturer (including OEM/ODM) 101 can obtain multiple licenses, each having respective passwords that can be recognized by the portal. The manufacturer (including OEM/ODM) 101 can then give one or more of the allocated licenses and respective passwords to designated distributors 103, retailers 107, service centers 105, or other manufacturers (including OEM/ODM) 101, thus providing access to the portal. The manufacturer (including OEM/ODM) 101 can also choose to obtain only one license but create multiple users covered by that license. This option enables many employees and/or partners within a single facility to use the service, and also provides for coverage of many different brands of products under a single roof.

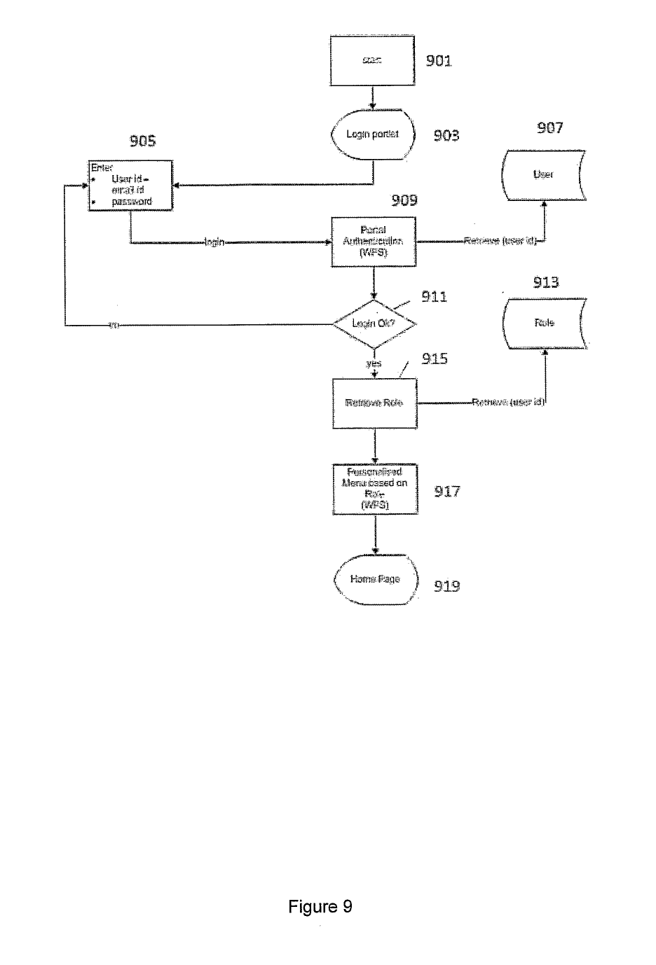

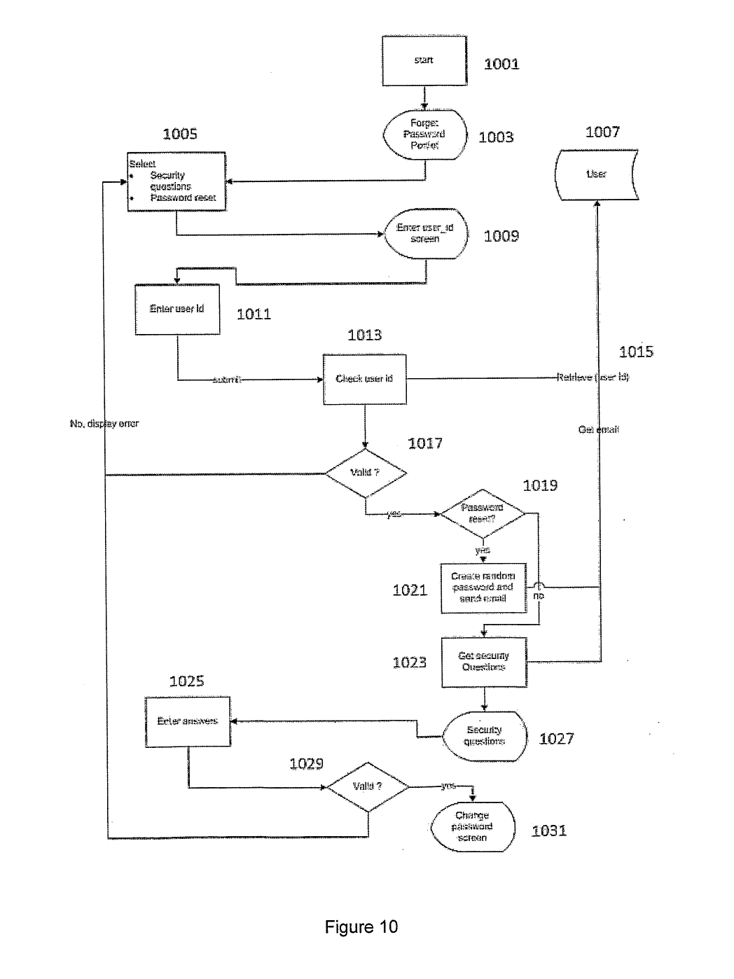

At step 205, a manufacturer (including OEM/ODM) 101, for example, can login to access the portal using a designated user ID and password. In case the manufacturer (including OEM/ODM) 101 forgets the password, at step 207 a request is made to the portal to send the password via e-mail. Upon identification, a correct password is sent to the manufacturer (including OEM/ODM) 101 via e-mail at step 209. (See FIGS. 9 and 10 below for the details of the login and forgotten password processes.)

In case a login is successful at step 211, a manufacturer (including OEM/ODM) 101, who is also a partner, has the right to scan, upload, or enter/update manually information related to the various products manufactured. The manufacturer (including OEM/ODM) 101 can also route products to a variety of destinations based on that information. The manufacturer (including OEM/ODM) 101 can designate a range of serial numbers for products to send to a given market. The system will then provide a list of all partner distribution centers 103 in that market. (The distribution centers in question will have entered their contact information through the portal, so it is not necessary for other partners to enter the information manually.) A destination can then be chosen from that list.

The product information from the manufacturer (including OEM/ODM) 101 can be uploaded into the portal's database using, for example, a barcode/RFID, an RSS feeding, or an excel sheet/CSV/XML format. For extracting information, the manufacturer (including OEM/ODM) 101 can use a “mashup,” which is a web-based service that combines diverse visual interfaces and/or data into a single site. Uploading the information found through a mashup enables proper routing of items. The information of a product includes a brand name, model name, model number, date of manufacture, place of manufacture, warranty details, serial number, stock keeping unit (SKU) number, International Mobile Equipment Identity (IMEI) number, Universal Product Code (UPC), etc.

In addition, the manufacturer (including OEM/ODM) 101 can provide or update information of distributors 103, service centers 105, and retailers 107 of each product manufactured. The information uploaded, entered, updated and routed by the manufacturer (including OEM/ODM) 101 can be accessed by any distributors 103, service centers 105, retailers 107 and end users/consumers 115 who are partners to the portal. While product updates are periodic, contact information for partners will need to be updated only in the event of major changes (opening of new partners, closing of old ones, etc.).

A manufacturer (including OEM/ODM) 101 who is also a partner to the portal can obtain a variety of information, such as region-wise, country-wise, distributor-wise, service center-wise, retailer-wise, product-wise, model-wise or customer-wise information about the failure rate, inventory status, failure details, return rates, etc., based on the previously uploaded, entered, updated and routed information of the various products handled by the partners (distributors, service centers, retailers, end users/consumers) of the portal. The manufacturer (including OEM/ODM) 101 can also create a link to that information for its partners. Any information entered by one partner can be seen by all partners. Each partner in the portal can also extend a product's warranty in accordance with the relevant terms and conditions, and can recall products. Partners can also change or reset user identifications and passwords at any time. Additionally, they can generate “client reports,” keeping all parties apprised of any given case even if it does not affect them directly.

A manufacturer (including OEM/ODM) 101 who is also a partner to the portal can benefit from the system and its access to information in a number of ways. Through the portal, partners can request options such as product swaps, reselling options, warranty extensions, etc.; this provides the manufacturer (including OEM/ODM) 101 with an additional revenue stream over that generated by product sales. The centralized integration of all partners reduces communications costs and improves efficiency in product deliveries. Through the one-stop source of contact information that brings many products under one roof, a manufacturer (including OEM/ODM) 101 can widen its customer base through direct contact with partners to which it would otherwise have no direct access. The improved communication base offered by embodiments of the present invention also enables better and more direct customer support, since end users/consumers 109 have a direct line of communication to the partners through which to address problems with their purchases.

At step 213, after using the system, the manufacturer (including OEM/ODM) 101 ends accessing the portal.

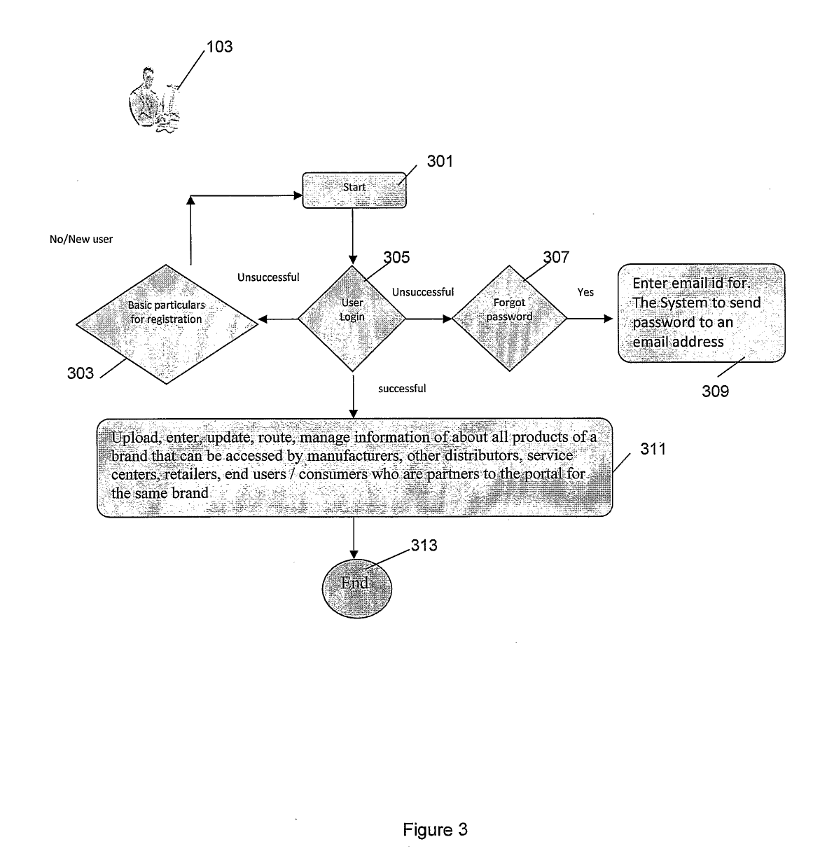

FIG. 3 is a flow chart showing a distributor 103 using the system of FIG. 1b. In case a distributor 103, dealing with a single brand or many brands of products, wishes to become a partner to the portal, at step 301 the distributor 103 starts by accessing a portal having a domain name. The portal has provisions for new registration at step 303. (See FIG. 8 below for the details of the registration process.) Subject to completing the registration formalities and license conditions, at least one user ID and password are allocated to the distributor 103.

A distributor 103, who wishes to become a partner, may need to complete the registration formalities only once. After this is done, the distributor 103 becomes a partner for all brands handled by manufacturers (including OEM/ODM) 101, service centers 105, and retailers 107 that are also partners. The distributor 103 with a user ID can be allocated one or more passwords that are identifiable by the portal. That password enables the distributor to access information about quantity shipped to a given destination, warranties, dates shipped and received, etc. for all brands handled by that distributor 103.

Furthermore, depending on terms and conditions, a distributor 103 can obtain multiple licenses, each having respective passwords that can be recognized by the portal. The distributor 103 can then give one or more of the allocated licenses and respective passwords to designated retailers 107, service centers 105, or other distributors 103, thus providing access to the portal. The distributor 103 can also choose to obtain only one license but create multiple users covered by that license. This option enables many employees and/or partners within a single facility to use the service, and also provides for coverage of many different brands of products under a single roof.

At step 305, a distributor 103, for example, can login to access the portal using a designated user ID and password. In case the distributor 103 forgets the password, at step 307 a request is made to the portal to send the password via e-mail. Upon identification, a correct password is sent to the distributor 103 via e-mail at step 309. (See FIGS. 9 and 10 below for the details of the login and forgotten password processes.)

In case a login is successful at step 311, a distributor 103, who is also a partner, has the right to scan, upload, or enter/update manually information related to the various products distributed. The distributor 103 can also route products to a variety of destinations based on that information. The distributor 103 can designate a range of serial numbers for products to send to a given market. The system will then provide a list of all partner retailers 107 in that market. (The retailers 107 in question will have entered their contact information through the portal, so it is not necessary for other partners to enter the information manually.) A destination can then be chosen from that list.

The product information from the distributor 103 can be uploaded into the portal's database using, for example, a barcode/RFID, an RSS feeding, or an excel sheet/CSV/XML format. For extracting information, the distributor 103 can use a “mashup,” which is a web-based service that combines diverse visual interfaces and/or data into a single site. Uploading the information found through a mashup enables proper routing of items. The information of a product includes a brand name, model name, model number, date of manufacture, place of manufacture, warranty details, serial number, stock keeping unit (SKU) number, International Mobile Equipment Identity (IMEI) number, Universal Product Code (UPC), etc.

In addition, the distributor 103 can provide or update information of manufacturers (including OEM/ODM) 101, service centers 105, retailers 107, and other distributors 103 of each product manufactured. The information uploaded, entered, updated and routed by the distributor 103 can be accessed by any manufacturers (including OEM/ODM) 101, service centers 105, distributors 103 and retailers 107 who are partners to the portal. While product updates are periodic, contact information for partners will need to be updated only in the event of major changes (opening of new partners, closing of old ones, etc.).

In case a manufacturer (including OEM/ODM) 101/distributor 103/service center 105/retailer 107 of a brand is a partner to the portal, a distributor 103 who is also a partner to the portal can obtain a variety of information, such as region-wise, country-wise, distributor-wise, service center-wise, retailer-wise, product-wise, model-wise or customer-wise information about the failure rate, inventory status, failure details, return rates, etc. based on the previously uploaded, entered, updated and routed information of the various products handled by the partners (manufacturers including OEM/ODM 101, service centers 105, retailers 107) of the portal. The distributor 103 can also create a link to that information for its partners. Any information entered by one partner can be seen by all partners. Each partner in the portal can also extend a product's warranty in accordance with the relevant terms and conditions, and can recall products. Partners can also change or reset user identifications and passwords at any time. Additionally, they can generate “client reports,” keeping all parties apprised of any given case even if it does not affect them directly.

In case the manufacturer (including OEM/ODM) 101/service center 105/retailer 107 of a brand is not a partner to the portal, the distributor 103 can provide standalone information (related to only specific products distributed by the distributor 103) to the partners (service centers 105, retailers 107, end users/consumers 115) of the portal that dealt with the specific products of the distributor 103. Under the standalone mode, a distributor 103 can obtain information based on the previously uploaded, entered, updated and routed information of the specific products handled by the partners (manufacturers including OEM/ODM 101, service centers 105, retailers 107, end users/consumers 115) of the portal. In keeping with the principle of many brands under one roof, the available information includes region-wise, country-wise, service center-wise, retailer-wise, customer-wise information about the failure rate, inventory status, failure details, return rates, etc., of those products that were distributed by the distributors 103.

A distributor 103, who is also a partner, can benefit from embodiments of the present invention and its access to information in a number of ways. Rather than awaiting word for partner retailers 107, a distributor 103 can track sales of products it handles directly, and thus anticipate future demand with increased accuracy and efficiency. Product promotions and product swaps can have a substantial impact on short-term ordering trends for a distributor 103; with embodiments of the present invention, information on promotions will be available more quickly and on more dependable terms. Similarly, a distributor 103 can keep abreast of any changes in the warranty process for all products it handles, simply by accessing information entered into the portal by partners. The increased ease and efficiency of communications can also streamline the returns management process, improving the responsiveness of a distributor 103 and decreasing its transportation costs. The system's links to logistics providers 111 provide a variety of options for the distributor 103's shipping needs. Finally, tracking inflow and outflow of products can be made much easier through the system: if the manufacturer (including OEM/ODM) 101 of a given product is a partner, the information necessary for tracking will already be in the system before the product arrives at the distribution centre 103.

At step 313, after using the system, the distributor 103 ends accessing the portal.

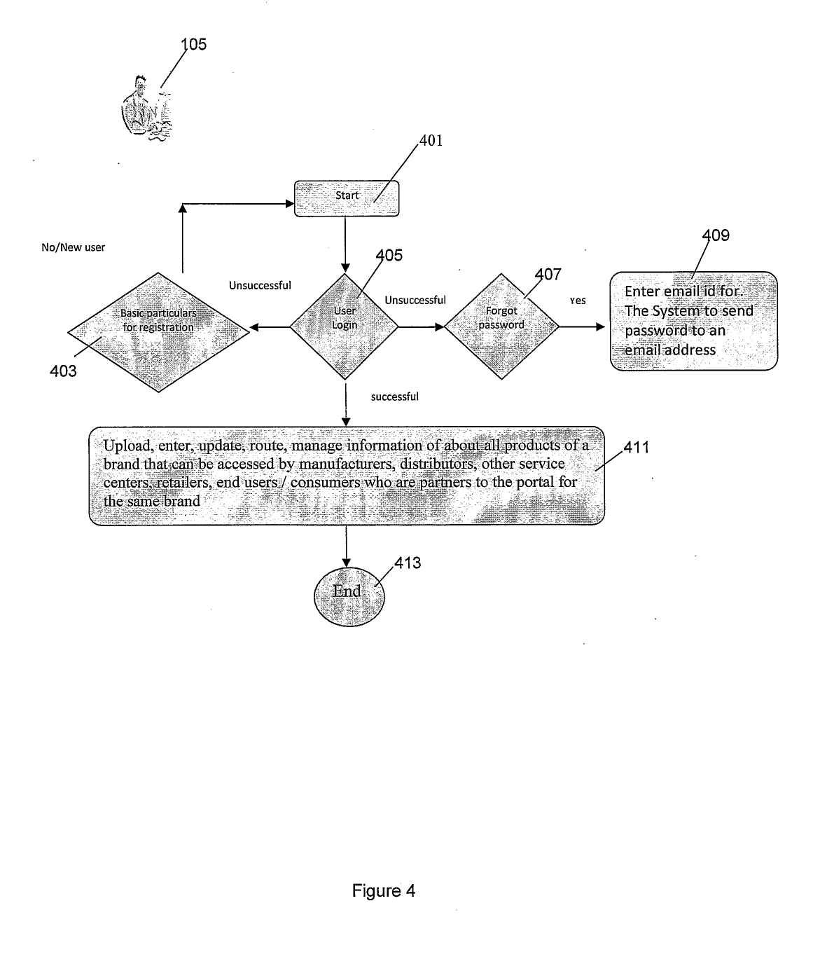

FIG. 4 is a flow chart showing a service center 105 using the system of FIG. 1b. In case a service center 105, dealing with a single brand or many brands of products, wishes to become a partner to the portal, at step 401 the service center 105 starts by accessing a portal having a domain name. The portal has provisions for new registration at step 403. (See FIG. 8 below for details of the registration process.) Subject to completing the registration formalities and license conditions, at least one user ID and password are allocated to the service center 105.

A service center 105 that wishes to become a partner may need to complete the registration formalities only once. After this is done, the service center 105 becomes a partner for all brands handled by manufacturers (including OEM/ODM) 101, distributors 103 and retailers 107 that are also partners. The service center 105 with a user ID can be allocated one or more passwords that are identifiable by the portal. That password enables the distributor to access information about quantity shipped to a given destination, warranties, dates shipped and received, etc. for all brands handled by that service center 105.

Furthermore, depending on terms and conditions, a service center 105 can obtain multiple licenses, each having respective passwords that can be recognized by the portal. The service center 105 can then give one or more of the allocated licenses and respective passwords to designated manufacturers (including OEM/ODM) 101, retailers 107, distributors 103, or other service centers 105, thus providing access to the portal. The service center 105 can also choose to obtain only one license but create multiple users covered by that license. This option enables many employees and/or partners within a single facility to use the service, and also provides for coverage of many different brands of products under a single roof. Finally, the service center 105 administrator can create additional accounts for service technicians at no extra cost, and can tailor the technicians' accounts with only the specific privileges they need.

At step 405, a service center 105, for example, can login to access the portal using a designated user ID and password. In case the service center 105 forgets the password, at step 407 a request is made to the portal to send the password via e-mail. Upon identification, a correct password is sent to the service center 105 via e-mail at step 409. (See FIGS. 9 and 10 below for the details of the login and forgotten password processes.)

In case a login is successful at step 411, a service center 105, who is also a partner, has the right to scan, upload, enter/update and route information related to the various products serviced. Uploading information will only be necessary in the case of products whose information was not already entered by the partners, such as the manufacturers (including OEM/ODM) of the products. The data from the service center 105 can be uploaded into the portal's database using, for example, barcode or an excel sheet format. The information of a product includes a brand name, model name, model number, warranty details, serial number, stock keeping unit (SKU) number, International Mobile Equipment Identity (IMEI) number, Universal Product Code (UPC), Electronics Product Code (EPC), European Article Number (EAN) or any other identification number, as well as retailer and/or distributor identification details, and purchase information.

In the case of products that were already entered into the system, the service center 105 can enter updates such as the nature of the job performed at the center (a single service or multiple services) and what parts if any were necessary for the repair. It is also possible to monitor engineering key performance, job status, inventory, failure rates for parts and models, claims, etc. In the process of performing a repair, the service center 105 can also access information entered by the customer/end user 115 regarding the nature of the problem, any remedies already attempted, etc. The service center 105 can also communicate directly with a consumer/end user 115 via the system in order to agree upon a price for the repair.

The service center 105 can also submit material requests for replacement parts from a partner such as a manufacturer (including OEM/ODM) 101 or distributor 103, or act as a parts seller for partners such as other service centers 105. The service center 105 can designate a range of serial numbers for products comparable to the one at hand in a given case. The system 100 provides a list of all partner distributors 103, manufacturers (including OEM/ODM) 101, and service centers 105 in that market. (The prospective partners in question will have entered their contact information through the portal, so it is not necessary for the service center 105 to enter the information manually.) A partner can then be chosen from that list. Similarly, the service center 105 can dispose responsibly of discarded products and parts by submitting a recycling request to recyclers 109. All interested recyclers 109 can then contact the service center 105 via contact information provided by the system.

The information uploaded, entered, updated or routed by the service center 105 can be accessed any manufacturer (including OEM/ODM) 101, distributor 103, other service center 105, retailer 107 or end user/consumer 115 who is already a partner to the portal.

In case a manufacturer (including OEM/ODM) 101/distributor 103/service center 105/retailer 107 of a brand is a partner to the portal, a service center 105, who is also a partner to the portal, can obtain information, such as region-wise, country-wise, distributor-wise, service center-wise, retailer-wise, product-wise, model-wise or customer-wise information about the failure rate, inventory status, failure details, return rates, etc. based on the previously uploaded, entered, updated or routed information of the various products handled by the partners (distributors 103, other service centers 105, retailers 107, end users/consumers 115) of the portal. The service center 105 can also create a link to that information for its partners. Any information entered by one partner can be seen by all partners. Each partner in the portal can also extend a product's warranty in accordance with the relevant terms and conditions, and can recall products. Partners can also change or reset user identifications and passwords at any time. Additionally, they can generate “client reports,” keeping all parties apprised of any given case even if it does not affect them directly.

In case the manufacturer (including OEM/ODM) 101/distributor 103/service center 105/retailer 107 of a brand is not a partner to the portal, the service center 105 can provide standalone information (related to only specific products serviced by the service center 105) to the partners (distributors 103, retailers 107, other service centers 105, and end users/consumers 115) of the portal that dealt with the specific products of the service center 105. Under the standalone mode, a service center 105 can obtain information based on the previously uploaded, entered, updated and routed information of the specific products handled by the partners (manufacturers including OEM/ODM 101, distributors 103, other service centers 105, retailers 107, end users/consumers 115) of the portal. In keeping with the principle of many brands under one roof, the available information includes region-wise, country-wise, service center-wise, retailer-wise, customer-wise information about the failure rate, inventory status, failure details, return rates, etc., of those products that were serviced by the service center 105.

A service center 105, who is also a partner, can benefit from embodiments of the present invention and its access to information in a number of ways. The centralized and streamlined communication provided by embodiments of the present invention extends to intra-center communication, so it can provide a large service center 105 with improved internal communications and center management. Among other things, this is useful with respect to service status monitoring: all concerned (both inside and outside the service center 105) can keep abreast of the status of a given service case. Failure status reports will be available for all interested parties as well, and an automated notification can be sent to the appropriate partner or partners when a repair is complete. Prior to completion, cost estimations can be made available to interested partners through the portal. Information on terms and conditions is also configurable and can be changed as needed.

Service centers 105 often serve different types of clients (walk-in customers, retailers 107, distribution centers 103, etc.) with fundamentally different needs; embodiments of the present invention can make it much easier to route cases of different clients and group them according to their unique needs. For each individual case, all important information such as the item's warranty status is available immediately and in one place. In the event of varying size and format of identification numbers (serial numbers, etc.) for different partners, data sizes and configurations can be customized to fit the needs of each service center 105. The size of each batch of items is also customizable: there is no upper or lower limit on the number of cases in a batch.

At step 413, after using the system, the service center 105 ends accessing the portal.

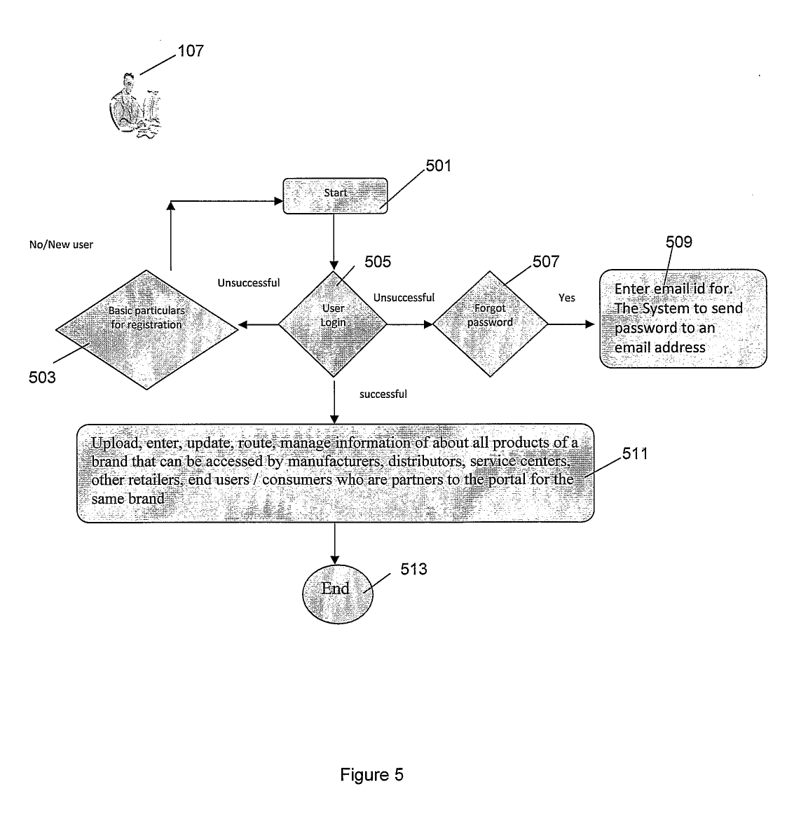

FIG. 5 is a flow chart showing a retailer 107 using the system of FIG. 1b. In case a retailer 107, dealing with a single brand or many brands of products, wishes to become a partner to the portal, at step 501 the retailer 107 starts by accessing a portal having a domain name. The portal has provisions for new registration at step 503. (See FIG. 8 below for the details of the registration process.) Subject to completing the registration formalities and license conditions, at least one user ID and password are allocated to the retailer 107.

A retailer 107, who wishes to become a partner, may need to complete the registration formalities only once. After this is done, the retailer 107 becomes a partner for all brands handled by manufacturers (including OEM/ODM) 101, distributors 103 and service centers 105 that are also partners. The retailer 107 with a user ID can be allocated one or more passwords that are identifiable by the portal. That password enables the distributor to access information about quantity shipped to a given destination, warranties, dates shipped and received, etc. for all brands handled by that retailer 107.

Furthermore, depending on terms and conditions, a retailer 107 can obtain multiple licenses, each having respective passwords that can be recognized by the portal. The retailer 107 can then give one or more of the allocated licenses and respective passwords to designated manufacturers (including OEM/ODM) 101, other retailers 107, distributors 103, or service centers 105, thus providing access to the portal. The retailer 107 can also choose to obtain only one license but create multiple users covered by that license. This option enables many employees and/or partners within a single facility to use the service, and also provides for coverage of many different brands of products under a single roof.

At step 505, a retailer 107, for example, can login to access the portal using a designated user ID and password. In case the retailer 107 forgets the password, at step 507 a request is made to the portal to send the password via e-mail. Upon identification, a correct password is sent to the retailer 107 via e-mail at step 509. (See FIGS. 9 and 10 below for the details of the login and forgotten password processes.)

In case a login is successful at step 511, a retailer 107, who is also a partner, has the right to scan, upload, view, enter/update and route information related to the various products sold by the retailer 107. Uploading information will only be necessary in the case of products whose information was not already entered by the partners, such as the manufacturers (including OEM/ODM) of the products. The data from the retailer 107 can be uploaded into the portal's database using, for example, a barcode or an Excel sheet format. The information of a product includes a brand name, model name, model number, warranty details, serial number, stock keeping unit (SKU) number, International Mobile Equipment Identity (IMEI) number, Universal Product Code (UPC) or any other identification number, as well as retailer and/or distributor identification details, and purchase information.

The product information from the retailer 107 can be uploaded into the portal's database using, for example, a barcode/RFID, an RSS feeding, or an excel sheet/CSV/XML format. For extracting information, the retailer 107 can use a “mashup,” which is a web-based service that combines diverse visual interfaces and/or data into a single site. Uploading the information found through a mashup enables proper routing of items. The information of a product includes a brand name, model name, model number, date of manufacture, place of manufacture, warranty details, serial number, stock keeping unit (SKU) number, International Mobile Equipment Identity (IMEI) number, Universal Product Code (UPC), etc.

In addition, the retailer 107 can provide or update information of manufacturers (including OEM/ODM) 101, distributors 103, service centers 105 and other retailers 107 of each product manufactured. The information uploaded, entered, updated and routed by the retailer 107 can be accessed by any manufacturers (including OEM/ODM) 101, distributors 103, service centers 105 and retailers 107 who are partners to the portal. While product updates are periodic, contact information for partners will need to be updated only in the event of major changes (opening of new partners, closing of old ones, etc.).

In case a manufacturer (including OEM/ODM) 101/distributor 103/service center 105/retailer 107 of a brand is a partner to the portal, a retailer 107 dealing with the brand, who is also a partner to the portal, can obtain information, such as region-wise, country-wise, distributor-wise, service center-wise, retailer-wise, product-wise, model-wise or customer-wise information about the failure rate, inventory status, failure details, return rates, etc., based on the previously uploaded, entered, updated or routed information of the various products handled by the partners (distributors, service centers, retailers, end users/consumers) of the portal. The retailer 107 can also create a link to that information for its partners. Furthermore, a retailer 107 can manage the product returns of distributors 103 or service centers 105. In addition, a retailer 107 can link with courier companies for handling product returns. Any partner in the portal can also extend a product's warranty in accordance with the relevant terms and conditions, and can recall products. Partners can also change or reset user identifications and passwords at any time.

In case the manufacturer (including OEM/ODM) 101/distributor 103/service center 105/retailer 107 of a brand is not a partner to the portal, the retailer 107 can provide standalone information (related to only those products handled by the retailer 107) to the partners (distributors 103, service centers 105, other retailers 107, end users/consumers 115) of the portal that dealt with the specific products of the retailer 107. Under the standalone mode, a retailer 107 can obtain information based on the previously uploaded, entered, updated and routed information of the specific products handled by the partners (distributors 103, service centers 105, other retailers 107) of the portal. In keeping with the principle of many brands under one roof, the available information includes region-wise, country-wise, service center-wise, retailer-wise, customer-wise information about the failure rate, inventory status, failure details, return rates, etc., of those products that were handled by the retailer 107.

A retailer 107, who is also a partner, can benefit from embodiments of the present invention and its access to information in a number of ways. The improved communication offered with partners enables a retailer 107 to respond more promptly and accurately to any and all queries from end users/consumers 115, thus improving customer retention and potentially broadening the customer base. This applies to returns management and product replacement, as well as information about availability of new or out-of-stock items. Placing and tracking of orders is also faster and more efficient, whether in the case of customer orders or new shipments from a distribution center 103 (with whom an online purchase order can be submitted immediately). The increased communications efficiency applies to internal communication as well, so inventory keeping can also be run more smoothly and accurately.

At step 513, after using the system, the retailer 107 ends accessing the portal.

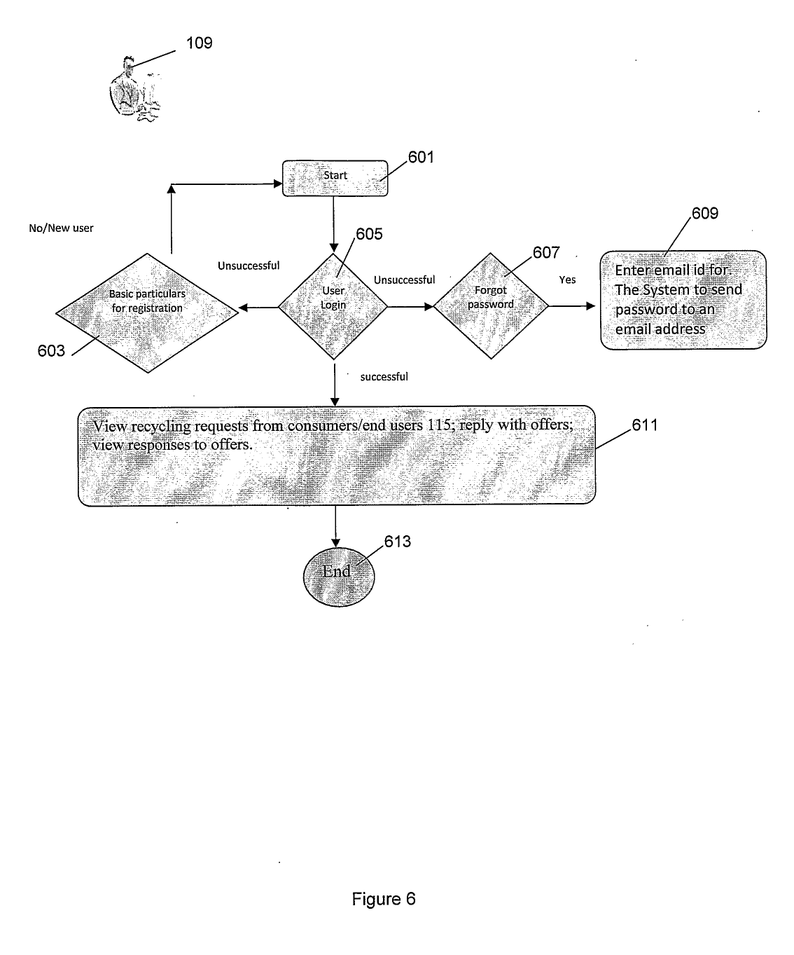

FIG. 6 is a flow chart showing a recycler 109 using the system of FIG. 1b. In case a recycler 109, dealing with a single brand or many brands of products, wishes to become a partner to the portal, at step 601 the recycler 109 starts by accessing a portal having a domain name. The portal has provisions for new registration at step 603. (See FIG. 8 below for the details of the registration process.) Subject to completing the registration formalities and license conditions, at least one user ID and password are allocated to the recycler 109.

A recycler 109 with a user ID can be allocated one or more passwords that are identifiable by the portal. That password enables the distributor to access information about quantity shipped to a given destination, warranties, dates shipped and received, etc. for all brands handled by that recycler 109.

Furthermore, depending on terms and conditions, a recycler 109 can obtain multiple licenses, each having respective passwords that can be recognized by the portal. The recycler 109 can then give one or more of the allocated licenses and respective passwords to designated service centers 105 or other recyclers 109, thus providing access to the portal. The recycler 109 can also choose to obtain only one license but create multiple users covered by that license. This option enables many employees and/or partners within a single facility to use the service.

At step 605, a recycler 109, for example, can login to access the portal using a designated user ID and password. In case the recycler 109 forgets the password, at step 607 a request is made to the portal to send the password via e-mail. Upon identification, a correct password is sent to the recycler 109 via e-mail at step 609. (See FIGS. 9 and 10 below for the details of the login and forgotten password processes.)

In case a login is successful at step 611, a recycler 109 has the right to field recycling requests from all consumers/end users 115 who search for recycling services within their respective locales. When prospective clients file a request through the system, the request is sent to all recyclers 109 that are partners in the geographic area. Each recycler 109 then has the option of offering a price to the consumer/end user 115, who can then accept or reject the offer through the system. If the consumer/end user 115 accepts the recycler 109's offer, the recycler 109 must then make arrangements to collect the item. This can be done through the system's links to various logistics providers 111.

A recycler 109, who is also a partner can provide or update information of manufacturers (including OEM/ODM) 101, distributors 103, service centers 105, and retailers 107 of each product manufactured. The information uploaded, entered, updated and routed by the recycler 109 can be accessed by any manufacturers (including OEM/ODM) 101, distributors 103, service centers 105 and retailers 107 who are partners to the portal. While product updates are periodic, contact information for partners will need to be updated only in the event of major changes (opening of new partners, closing of old ones, etc.).

A recycler 109, who is also a partner, can benefit from embodiments of the present invention and its access to information in a number of ways. The system's direct links to all end users/consumers 115 who are seeking recycling services raises visibility to potential clients. The improved communication offered with partners enables a recycler 109 to respond more promptly and accurately to any and all requests from end users/consumers 115, thus improving customer retention and potentially broadening the customer base. Setting an agreed-upon price for recycling services is also faster and more efficient, and reduces the risk of payment disputes later in the process. The increased communications efficiency applies to internal communication as well, so inventory keeping can also be run more smoothly and accurately.

At step 613, after using the system, the recycler 109 ends accessing the portal.

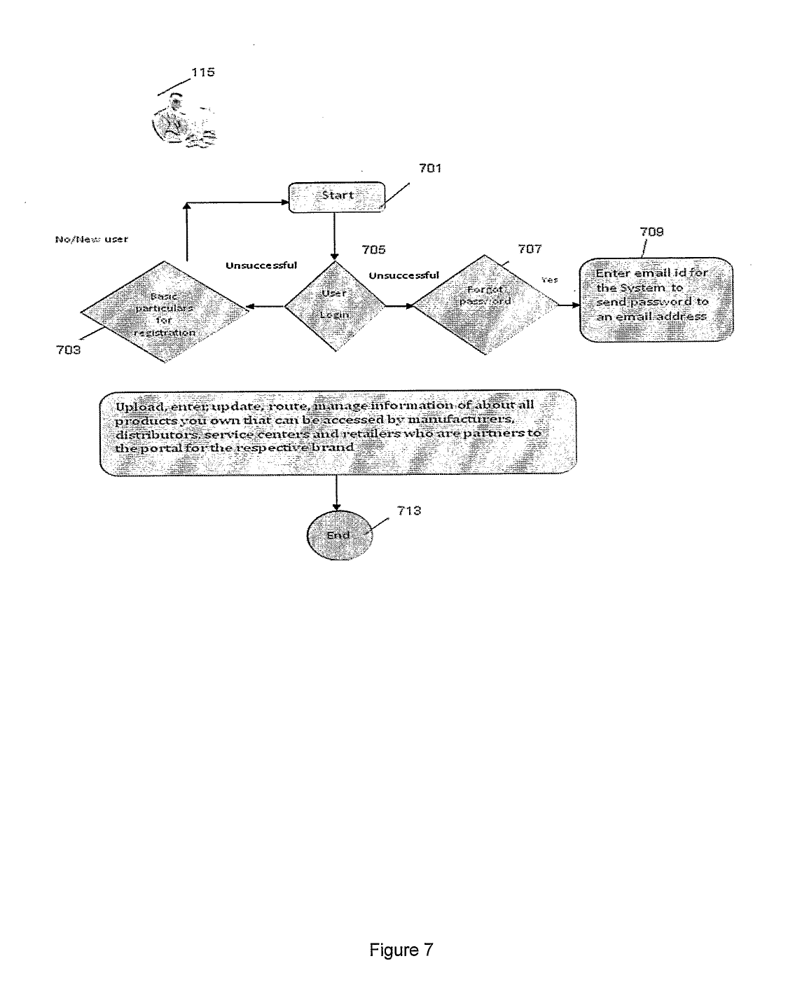

FIG. 7 is a flow chart showing an end user/consumer 115 using the system of FIG. 1b. In case an end user/consumer 115, having purchased one or several products under one or various brands, wishes to become a partner to the portal, at step 701 the end user/consumer 115 starts by accessing a portal having a predefined address. The portal has provisions for new registration at step 703. Subject to completing the registration formalities and license conditions, a user ID and password is allocated to the end user/consumer 115. (See FIG. 8 below for the details of the registration process.) Using the allocated user ID and password, an end user/consumer 115 has no further registration formalities and is a partner for all brands of products.

At step 705, an end user/consumer 115, for example, can login to access the portal using a designated user ID and password. In case the end user/consumer 115 forgets the password, at step 707 a request is made to the portal to send the password via e-mail. Upon identification, a correct password is sent to the end user/consumer 115 via e-mail at step 709. (See FIGS. 9 and 10 below for the details of the login and forgotten password processes.)

In case a login is successful at step 711, an end user/consumer 115, who is also a partner, has the right to enter or update information related to the various products, and to upload an invoice, warranty card and/or product image. The information of a product includes a brand name, model name, model number, warranty details, serial number or any other manufacturing identification number, as well as retailer and/or distributor identification details and purchase information.

The information entered or updated by the end user/consumer 115 can be accessed by any manufacturer (including OEM/ODM) 101, distributor 103, service center 105 or retailer 107 who is already a partner to the portal.

In case a manufacturer (including OEM/ODM) 101/distributor 103/service center 105/retailer 107 of a brand is a partner to the portal, an end user/consumer 115 dealing with the brand, who is also a partner to the portal, can obtain information, such as product and respective warranty details, repair history, authorized and unauthorized service centers 105, authorized retailers 107, and promotions related to the brand of products in possession. Additionally, the end user/consumer 115 can use the portal to extend the warranty, obtain information on when to send and receive repaired goods (the job status being updated by partners), or receive and approve the quotations from service centers 105 for repairs or from recyclers 109 for recycling services, provide feedback about repairs, and place a request to send a repaired product by a courier.

In case the manufacturer (including OEM/ODM) 101/distributor 103/service center 105/retailer 107 of a brand is not a partner to the portal, the end user/consumer 115 can obtain information, such as product and respective warranty details, or repair history related to the brand of products in possession, on a standalone basis.

An end user/consumer 115 can benefit from embodiments of the present invention and its access to information in a number of ways. Up-to-date information such as the location of the nearest authorized or unauthorized service center 105 is available at all times through an information module. Service orders can be booked online, and can be tracked while in progress. The end user/consumer 115 can extend a product's warranty using embodiments of the payment gateway, and can keep track of all details of the warranty at all times. Information from partners about new products, as well as launch events and other promotional events, is available in the event that the end user/consumer 115 is interested, without e-mail “spam” or “junk mail”.

At step 713, after using the system, the end user/consumer 115 ends accessing the portal.

FIG. 8 is a flowchart showing the registration process using the system of FIG. 1b. In case a manufacturer (including OEM/ODM) 101, distributor 103, service centers 105, retailer 107, recycler 109 or end user/consumer 115 wishes to become a partner to the portal, the user starts at step 801, which leads directly to a Welcome Page (step 803). If partner is not already a member, the next step is step 805, registering.

If partner is a consumer (807), the next step is to proceed to the consumer registration page (809). On that page, the consumer enters (step 813) identifying information such as an e-mail address, and other details. The information is then submitted for validation (step 815). If the validation process yields an error (step 821), the consumer is directed back to step 813 and the process is repeated until the error is eliminated. The consumer's data is then saved (step 831), and an e-mail is sent to the consumer (step 839) including the consumer's password and account activation information. The data is also saved in the database (step 823), and the consumer has the option of redirecting to the welcome page (step 803) in order to sign in (step 811).

Any unregistered partner other than a consumer will proceed from step 807 to the company registration page (829). On that page, the partner enters (step 827) identifying information such as the name and type of the company, type of license etc. Completing this step leads to the create user page (step 837), where partner will enter additional information (step 835) similar to that entered by a consumer at step 813. The information is then submitted for validation (step 841). If the validation process yields an error (step 847), the consumer is directed back to step 827 and the process is repeated until the error is eliminated. Once the validation process is completed successfully, partner is directed to the select payment page (step 845), where payment details are entered (step 843). When the payment process is complete (step 849), the data is saved (step 831). An e-mail is then sent to the partner (step 839) including the partner's password and account activation information. The data is also saved in the database (step 817), and the partner has the option of redirecting to the welcome page (step 803) in order to sign in (step 811).

A partner (consumer or otherwise) who already is registered proceeds directly from step 805 to step 811. Signing in successfully leads to the login process (step 833), which is covered separately in FIG. 9. If sign-in is not successful, consumer will have the option to report a forgotten password (step 825). Doing so leads to the forget password process, which is covered in FIG. 10.

FIG. 9 is a flowchart showing the login process for registered users using the system of FIG. 1b. In case a partner wishes to login to the system, the user starts at step 901. Registered users can choose the login portlet (step 803). At the portlet, partner enters (step 905) the user ID and password. Once this is complete, partner is directed to the portal authentication stage (step 909). If the login is unsuccessful, partner can initiate the process of retrieving the user ID from the database (step 907). If the login is successful (step 911), partner is then prompted to retrieve the role (step 915) assigned to the individual using the program. If this is unsuccessful, partner can initiate the process of retrieving his or her role from the database (step 913). If step 915 is successful, partner will be directed automatically to a personalized menu (step 917) designed to fit the user's role. From there, partner can proceed to the home page (step 919) and commence working.

FIG. 10 is a flowchart showing the process for retrieving a lost or forgotten password using the system of FIG. 1b. In case a member wishes to change or retrieve a password, the user starts at step 1001. A registered user without access to the password will choose the forget password portlet (step 1003). Partner will then be presented with the option of a password reset (step 1005).

Answering the security question correctly will lead the user to the user id screen (step 1009), where the user will be prompted to enter his or her user ID (step 1011). The system then checks the ID (step 1013) and retrieves (step 1015) relevant information from the database. If the user ID entered is not valid, partner will be redirected to step 1005, where the process can be started again. If the user ID is valid (step 1017), partner will be offered the password reset option (step 1019). If partner chooses to have the system reset the password, the system 100 creates a random password (step 1021) that is sent to the user via e-mail. If partner prefers to reset the password manually, the user has the option to get security questions (step 1023). Both step 1021 and step 1023 will involve the system 100 communicating with the database (step 1033), but this does not necessitate any further action on the part of the user.

If the user chooses get security questions (1023), the questions will appear on the screen (step 1027). The questions and their answers will have been set during the registration process, and the user should be the only person able to provide the correct answer. (Examples include “What is your father's middle name?” or “What was the name of your first pet?”). After the user answers the questions (step 1025), the system 100 will check their validity (step 1029). If the answers are correct, the user will be directed to the change password screen (step 1031), where the user will be able to reset the password manually. If the answers are not valid, the user will be redirected to step 1005, where the process can be started again.

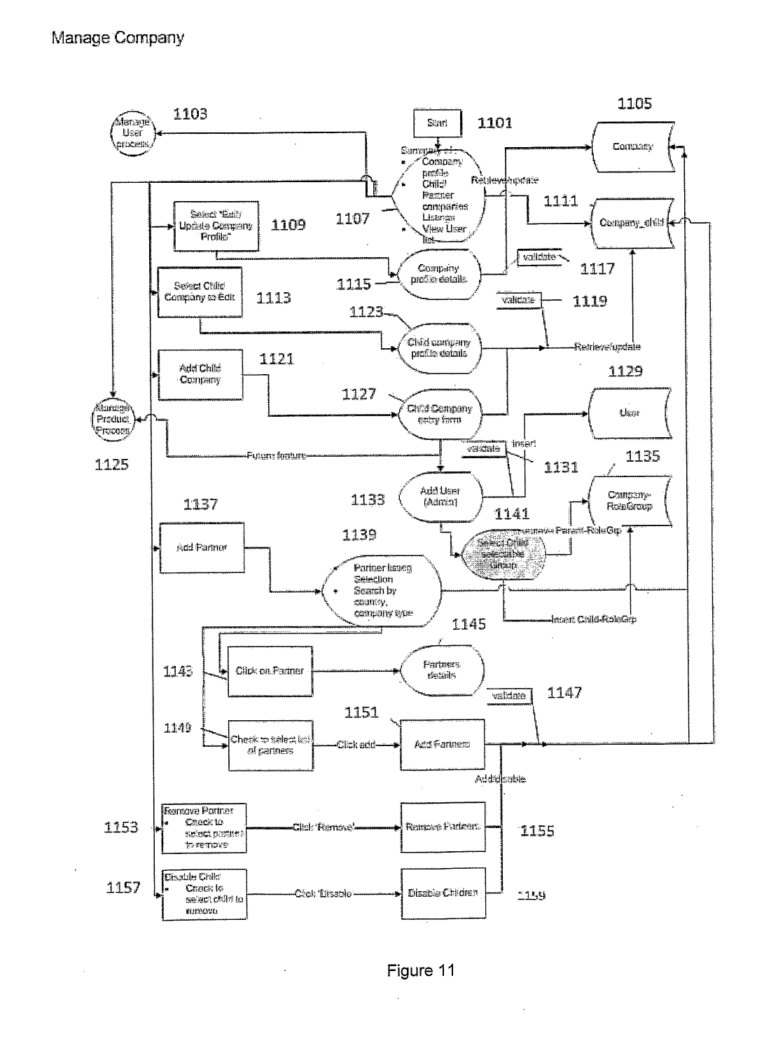

FIG. 11 is a flowchart showing the options partners have for managing their company accounts using the system of FIG. 1b. If a partner wishes to edit the parameters of the account, the user starts at step 1101. Embodiments of the present invention provide the option for partner to view a summary user interface (step 1107) featuring information on the company profile and any child-companies or partner-companies. This information is retrieved from the database (steps 1105 and 1111).

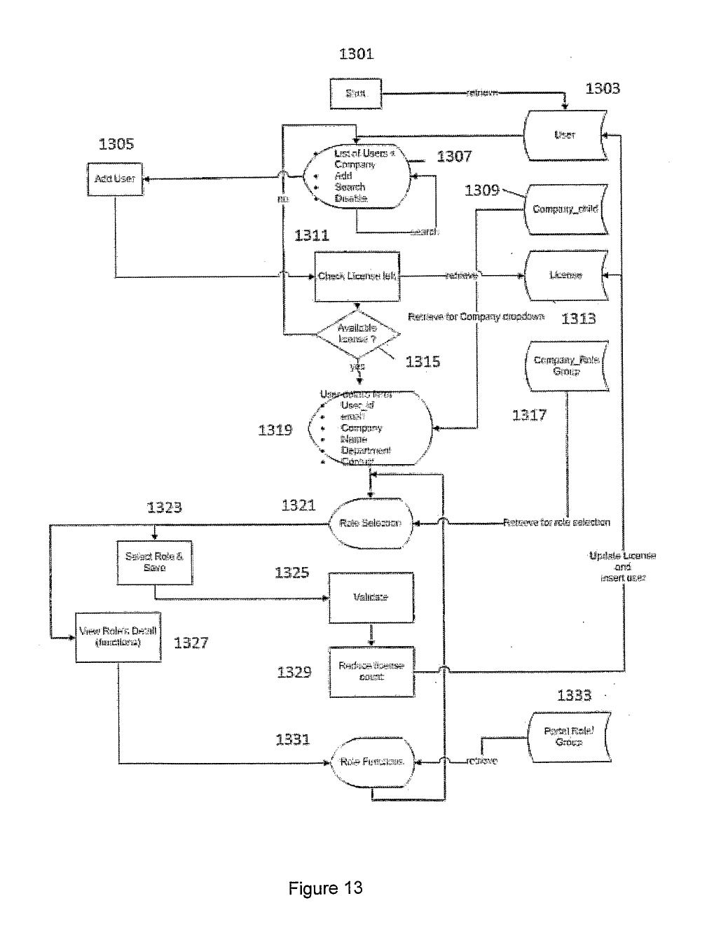

A partner has several options at this point:
Manage user process (step 1103): see FIG. 13 below for more details.
Edit/update company profile (step 1109): this option directs partner to a list of company profile details (step 1115), which the user can change as necessary. After validating the changes (step 1117), the information is stored under company in the database (step 1105).
Select child company to edit (step 1113): this option directs partner to a list of child company profile details (step 1123). Partner can then retrieve child company information from the database (step 1111) and edit the information as necessary. After validating the changes (step 1119), the newly updated information is saved in the database.
Add child company (step 1121): this option directs partner to a child company entry form (step 1127), on which the user can enter information on a newly formed or acquired child company. When the form is completed and validated (step 1119), it is stored in the database (step 1111). Partner can also add new users (step 1127) as necessary; after validation (step 1131), the new user information is saved in the database under user (step 1129). If necessary, partner can also file the new child companies and users into groups by choosing select child selectable group (step 1141). The groupings are then saved in the database under company role group (step 1135).
Manage product process (step 1125).
Add partner (step 1137): if partner wishes to connect with another company, the user can list partners (step 1139), searching by country and/or company type. The information will be retrieved from the database (steps 1105, 1111, 1135). Partner can then either click on partner (step 1143) and then access the potential partners' details (step 1145), or select a list of partners (step 1149) and then add partners (step 1151). After validating the choices (step 1147), the new contacts will be stored in the database (step 1105).
Remove partner (step 1153): from the list of partners provided in step 1107, the user checks the partner or partners to be removed, and clicks remove partners (step 1155). After validating the changes (step 1147), the updated list of partners will be stored in the database (step 1105).
Disable child (step 1157): from the list of child companies provided in step 1107, the user checks the child company or companies to be disabled, and clicks disable children (step 1159). After validating the changes (step 1147), the updated list of child companies will be stored in the database (step 1111).

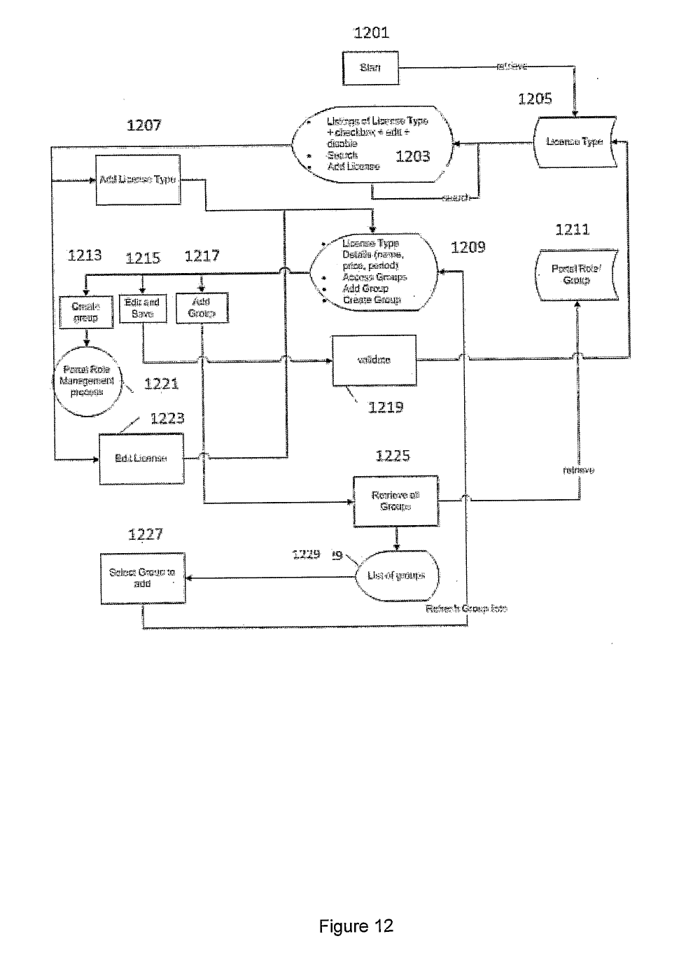

FIG. 12 is a flowchart showing the options partners have for managing their licenses using the system of FIG. 1b. If a partner wishes to edit the parameters of one or more licenses, the user starts at step 1201. The system 100 retrieves data on partner's license type (step 1205), which is then listed (1203) along with options to edit, disable, search and add license types.

If the user chooses to add a license type (step 1207) or edit an existing one (step 1223), the system 100 then proceeds to a licensing user interface (step 1209), where the user can create groups (step 1213), edit existing groups (step 1215) or add existing groups (step 1217). Creating a group leads to the portal role management process (step 1221), which is covered in detail below. The editing option will enable the user to change existing group information. The changes are then validated (step 1219) and stored in the license type database (step 1205).

Choosing the add groups option will lead the system 100 to retrieve all groups (step 1225) from the portal role/group database (step 1211). The system 100 will then provide the user with a list of groups (step 1229), from which the user can select one or more groups to add (step 1227). When this step is completed, the user is redirected to step 1209, where the updated group information can be viewed. If further changes are necessary, the process can be repeated starting at step 1209.

FIG. 13 is a flowchart showing the options partners have for managing their user accounts using the system of FIG. 1b. If a partner wishes to edit the parameters of one or more user accounts, the user starts at step 1301. The system 100 retrieves data on partner's registered users (step 1303). The data is then listed (step 1307) by user and respective company, along with options to disable, search and add users.

To add a user (step 1305), partner checks the relevant license validity (step 1311), using license information retrieved from the database (step 1313). It is then determined whether licensing is available for partner's new user (step 1315). If not, partner is redirected to step 1307, where other options can be considered. If the license is available, partner is directed to the user details form (step 1319), whose format is determined from information stored in the database (step 1309). Details that may be requested on the form include the new user's name, user ID, e-mail address, company, department and contact information.

After the form has been filled in, the system 100 proceeds to the role selection stage (step 1321), using information on roles from the database (step 1317). For a new user, partner can select role & save (step 1323), and then validate the choice (step 1325). The system 100 will then reduce count of available licenses for partner (step 1329), and save the updated licensing and user information under users in the database (step 1303).

If partner is not sure of the appropriate role for the new licensee, rather than selecting a role (step 1323) immediately, the operator can view role's detail (functions) (step 1327). Partner will then be directed to a role functions user interface (step 1331), which will retrieve information on roles from the database (step 1333). Partner can then make an informed decision regarding role selection, and will be redirected to step 1321 to complete the process.

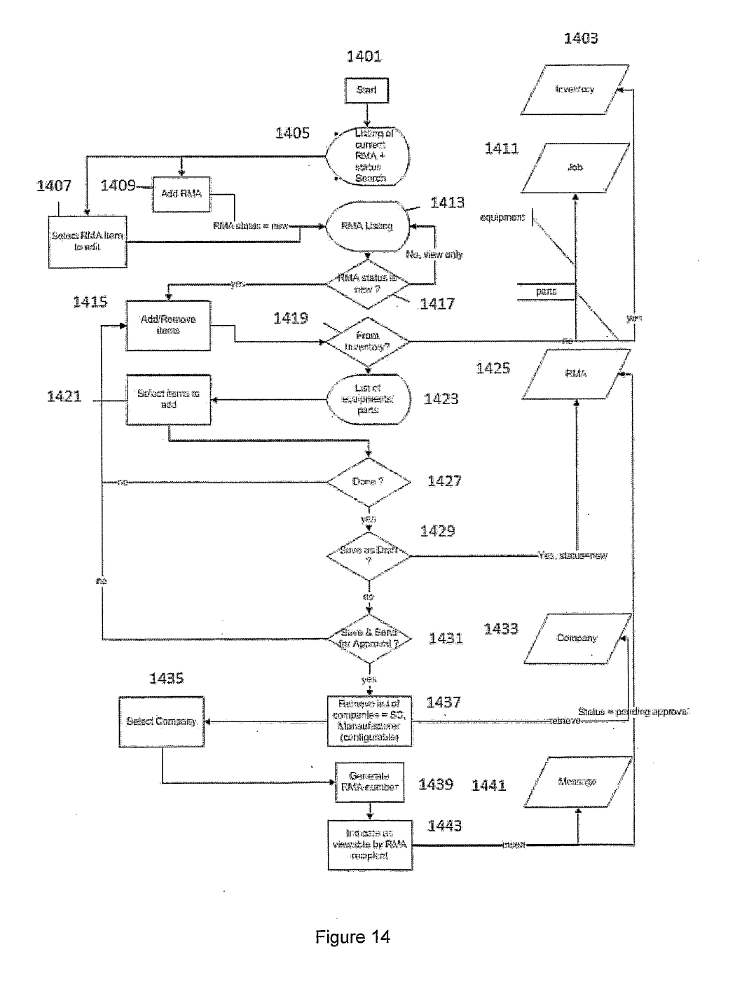

FIG. 14 is a flowchart showing the return material authorization (RMA) process using the system of FIG. 1b. RMA enables an end user/consumer 115 to determine whether or not a product is eligible for return under its warranty, and what the post-return options are. A manufacturer (including OEM/ODM 101, distributor 103, service center 105 and/or retailer 107 can also use RMA to communicate and make decisions regarding all return requests, as well as subsequent actions (repairs, replacements, exchanges for credit, etc.).

In case a partner wishes to login to the system, the user starts at step 1401. Registered users can view their currently-open RMA requests (submitted and/or received) at step 1405. A user can then edit an existing RMA item (step 1407) or create a new one (step 1409). Both options lead to the RMA Listing interface (step 1413). In the case of a new RMA item or changes to an existing one, RMA status is considered new (step 1417). The user is then given the option of adding or removing items (step 1415), and is directed to identify whether the changes will affect partner's inventory (step 1419). The updated information will be stored in the database (step 1403 if changes to inventory are involved, step 1411 if not).

If inventory changes are involved, the user is provided with a list of available parts and equipment (step 1423), and can select items from the list to add to the selected RMA request (step 1421). This process can be repeated as many times as necessary to update the request. When the update is complete (step 1427), the user has the option of saving the updated RMA request as a draft (step 1429), in which case it is stored in the database (step 1425). After the draft is saved, or if the user does not wish to save a draft, the RMA request can be sent for approval (step 1431). At this stage, the user has one last opportunity to return to step 1408 and update the request further.

After the user chooses to save and send the RMA request for approval, a list of potential partners is provided (step 1437). The type of partners provided on the list may depend on the role of the user. For example, if the user is an end user/consumer 115 wishing to return a defective product, a list of service centers 105 will be provided. If the user is a service center 105 in need of replacement parts, the list might consist of manufacturers OEM/ODM 101 and/or distributors 103.

If partner is checking on the status of a previously submitted RMA request, the user can select a company from the list and view the company's decision (approved, denied, pending, other) and/or whether or not a decision has been made (step 1433). In the case of a new or edited request, the user can select a new potential partner company from the list (step 1435). Once the selection has been made, an RMA number is generated (step 1439), and the user indicates the parameters of information that will be made available to the company receiving the RMA (step 1443). The user can enclose a message accompanying the request (step 1441). The request is then saved in the database in step 1425.

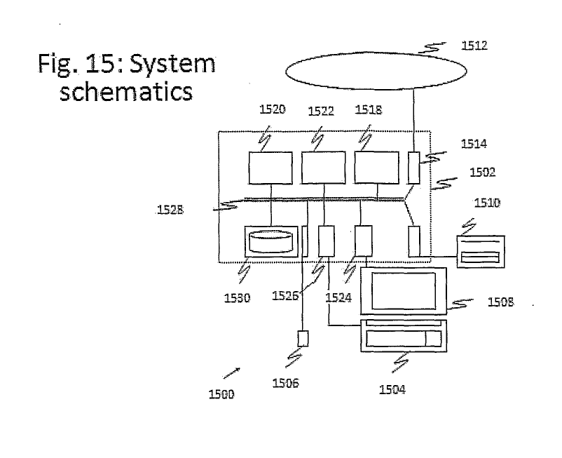

The method and system of the example embodiment can be implemented on a computer system 1500, schematically shown in FIG. 15. It may be implemented as software, such as a computer program being executed within the computer system 1500, and instructing the computer system 1500 to conduct the method of the example embodiment.

The computer system 1500 comprises a computer module 1502, input modules such as a keyboard 1504 and mouse 1506 and a plurality of output devices such as a display 1508, and printer 1510.

The computer module 1502 is connected to a computer network 1512 via a suitable transceiver device 1514, to enable access to e.g. network systems such as Local Area Network (LAN) or Wide Area Network (WAN).

The computer module 1502 in the example includes a processor 1518, a Random Access Memory (RAM) 1520 and a Read Only Memory (ROM) 1522. The computer module 1502 also includes a number of Input/Output (I/O) interfaces, for example I/O interface 1524 to the display 1508, and I/O interface 1526 to the keyboard 1504.

The components of the computer module 1502 typically communicate via an interconnected bus 1528 and in a manner known to the person skilled in the relevant art.

The application program is typically supplied to the user of the computer system 1500 encoded on a data storage medium such as a CD-ROM or flash memory carrier and read utilizing a corresponding data storage medium drive of a data storage device 1530. The application program is read and controlled in its execution by the processor 1518. Intermediate storage of program data may be accomplished using RAM 1520.

Embodiments of the present invention can help in achieving a number of advantageous results. A manufacturer (including OEM/ODM) 101 is likely to provide stock to distributors 103 and retailers 107 in a wide variety of overseas markets. The distance involved can make it difficult to keep abreast of market developments such as new distributors 103 or retailers 107, which can provide lucrative new sources of income if the manufacturer (including OEM/ODM) 101 is aware of them. Becoming aware of such new developments can be difficult and/or expensive, particularly at great distances.

However, if the manufacturer (including OEM/ODM) 101 is a partner, it has a direct link to all current partners in the markets where it operates, no matter how far away they are. Through this link, the manufacturer (including OEM/ODM) 101 gains an immediate link to any and all new actors in a given market through their links to the existing partners. This provides access to new markets in real time, as quickly as they are established. It also provides access to information about trends in those markets, so a manufacturer (including OEM/ODM) 101 can stay informed about sales trends, frequency of problems with products, and rates of returns, and can adjust its manufacturing practices accordingly.

Distributors 103 have a similar interest in sales trends and links to manufacturers (including OEM/ODM) 101. The more they know about a given product's popularity, the more accurately they can predict the demand they will have for that product from retailers 107 and thus their own demand from manufacturers (including OEM/ODM) 101. Just as the system of links provided by embodiments of the present invention will enable manufacturers (including OEM/ODM) 101 to take advantage of market developments, it will also enable distributors 103 to make contact with manufacturers (including OEM/ODM) 101 who are able and willing to provide products on the optimum terms, and with retailers 107 to supply with the products.

Through the system's links, distributors 103 can not only establish connections with new partners, they can keep abreast of relevant information about trade of products with those partners rather than awaiting reports from them. If a distributor 103 is linked with the above manufacturer (including OEM/ODM) 101, it will have immediate access to information about the exact products available from that manufacturer (including OEM/ODM) 101, as well as shipping distances and costs. It can also access sales information from its partner retailers 107, and make an informed decision, based on up-to-the-minute information, on the desirability of entering into a partnership with the manufacturer (including OEM/ODM) 101. If it does so, all relevant tracking information on the products will already be in the system when they arrive at the distribution center 103, having been entered at the manufacturer (including OEM/ODM) 101.

When those products are passed on to a retailer 107, the distributor 103 will be able to keep track of sales and returns alike at all partner retailers 107 through the links provided by the system 100. The links serve a number of purposes at this stage: as sales increase or decrease, the distributor 103 can be proactive in adjusting its orders from the manufacturer (including OEM/ODM) 101 accordingly. Rather than waiting for feedback from each retailer 107, the distributor 103 can simply collect sales information through the links. (This is also beneficial to the retailers 107, who can devote their time and resources to other matters rather than sending sales reports to the distributors 103.) The distributor 103 can also anticipate changes in sales rates when retailers 107 make plans for promotional events such as sales: the information will be available through the links. Similarly, changes in the warranty process can affect sales rates and are of interest to distributors 103; this information can also be made available through the links.

Embodiments of the present invention are beneficial to a retailer 107 with respect to both partnerships and internal operations. As with manufacturers (including OEM/ODM) 101 and distributors 103, retailers 107 have a direct interest in being linked to as many potential partners as possible and having immediate access to relevant information from them. They also benefit from the one-stop nature of embodiments of the present invention for the purpose of handling returns from customers/end users 115. At any given time, a retailer 107 is likely to have a number of return cases open with a variety of problems, circumstances and at different stages. Some products will require repairs, others will require replacement products, others will be functional and returned for credit. Some customers/end users 115 will not be immediately available to collect their newly repaired products, so short-term storage at the retailer 107 will be necessary. Since various retailer 107 staff will handle each case, no individual person is likely to be aware of all of the developments of even one case, much less all.

Embodiments of the present invention solve that problem with its one-stop repository of information. It also makes communication with customers/end users 115 much easier through its links. The retailer will no longer be obligated to take the initiative in contacting the customers/end users 115, or to try repeatedly in the event that they are not home. Instead, the customers/end users 115 will have access to the status of their case (repair, replacement, credit, etc.) through their links with both the retailer 107 and the service center 105. Indeed, the customer/end user 115 may not need to contact a retailer 107 at all, but can instead use the links to deal directly with a service center 105; the customer/end user 115 can even choose from a list of service centers 105 in his or her area. Queries about case status can be submitted online, without regard for the availability of a qualified staffer at the retailer 107 or service center 105 at the time the query is made. Partners also have a direct link to past and present customers/end users 115 if they wish to advertise new products, promotions, etc.

Service centers 105 stand to benefit from the increased availability of information about new potential partners, just as all other partners in the product cycle do. Embodiments of the present invention offer them several other potential benefits as well. The direct link to customers/end users 115 can save a great deal in transportation costs, since returned items can be sent directly to the service center 105 and back rather than going through the retailer 107 in some cases. It also facilitates much easier communication with concerned customers/end users 115. This can be lucrative in increasing customer satisfaction among a market that might otherwise be reluctant to remain loyal to the company since their purchases required repairs.

Information generated by the service centers 105 can also be valuable to partners who will access that information through the links. If a service center 105 receives a large number of a particular type of product from the above manufacturer (including OEM/ODM) 101, the manufacturer (including OEM/ODM) 101 will want information on the nature of the complaint so that it can work to eliminate the recurrence of the problem in the future. Distributors 103 and retailers 107 will also be interested in the failure rates, as they are likely to have an impact on demand for that product in the future. In the case of high-end items, a service center 105 that specializes in a particular model stands to benefit from links to all other partners concerned with that model, who will be especially interested in keeping customers/end users 115 happy.

Above all, the links provided by embodiments of the present invention reduce gaps and increase efficiency. Efficiency in communication, efficiency in reverse logistics, efficiency in responsiveness: all stand to benefit from better and faster communication. Embodiments of the present invention provide those improvements through links among all partners in a product cycle. Since many partners work with more than one product and/or more than one brand of product, embodiments of the present invention brings many brands under one roof. This is beneficial for customers/end users 115, who purchase a wide variety of products from a wide variety of brands. It is beneficial for distributors 103 and retailers 107, most of which distribute and sell a wide variety of products from a wide variety of brands. it is beneficial for manufacturers (including OEM/ODM) 101 and service centers 105: some of them produce and service a wide variety of products. Even those who do not will stand to benefit from more links with other partners, since the links will ultimately lead to more potential consumers for their products and services.

The links created by embodiments of the present invention provide increased effectiveness, and increased market sizes for all partners.

Embodiments of the present invention provide a single platform that can efficiently link and manage the reverse logistic process of all manufacturers (including OEM/ODM), distributors, retailers, service centers and end users/consumers. Furthermore, embodiments of the present invention provide a single, “under one roof solution” platform that can identify a product and give information through the lifecycle of the product to manufacturers (including OEM/ODM), distributors, retailers, service centers and end users/consumers.

Embodiments of the present invention provide a reverse logistics system to establish multiple one-to-one and many-to-many communication between any two or more of the manufacturers (including OEM/ODM), distributors, retailers, service centers, end users/consumers, wherein each of the party that is in mutual communication does not need its own database to manage the reverse logistic process. A centrally located database is sufficient to manage the reverse logistics of manufacturers (including OEM/ODM), distributors, retailers, service centers, and end users/consumers. Embodiments of the present invention eliminate the need of a distributor, retailer or service center dealing with a large number of products from various manufacturers (including OEM/ODM) to purchase a reverse logistics system. They can use embodiments of the present invention on a software as a service (SAAS) basis without buying it.

Embodiments of the present invention can achieve in reducing cost of returned merchandise. Embodiments of the present invention address the entire product cycle and can be suitable for use in any business.

Embodiments of the present invention offer information access for manufacturers (including OEM/ODM), distributors, service centers, retailers and end users thereby enabling them to track the progress of a given reverse order at all times.

Embodiments of the present invention provide a user-friendly graphical user interface (GUI) and dashboard, which can present information quickly and requires minimal user training. Since the embodiment of the present invention is a web-based reverse logistics system, it can be easily integrated to any existing systems through a mashup, web services, RSS feed, XML, excel, CVS, etc.

Embodiments of the present invention allow all segments of supply chains to access real-time information on all pending transactions including repairs, whereby the needed information can be promptly and accurately obtained by all the parties. Embodiments of the present invention can help in improving customer service and efficiency, by streamlining the reverse logistics tracking process, which can result in increased sale of products.

Embodiments of the present invention provide updated information about the addresses of manufacturer (including OEM/ODM) distributors, service centers and retailers, which can help efficient operation of businesses and consumers alike

Embodiments of the present invention can help in identifying a product provide its history from the date of manufacture.

The centralized availability of product information for a variety of companies enables businesses to communicate with each other quickly and efficiently. Increased information about products stocked by retailer or distributor can help in quicker sale of products.

The invention is not limited to the above embodiments. However, those skilled in the art will recognize that the invention can be practiced, with modification, in light of the information contained herein without departing from the scope of the invention. That scope amounts to an efficient, environmentally-friendly under-one-roof solution, through which a business or end user can manage all assets in one place.

1-33. (canceled)

34. A system for managing product information of one or more brands comprising:
a portal comprising an information processing system, the information processing system comprising a data base for storing one or more product information of a brand including identification information of one or more products of the brand, the product information including the identification information of the one or more product of the brand are entered by a first user having a first authentication information obtained by registering into the portal,
wherein the stored product information is accessible by one or more other users having respective authentication information obtained after registering with the portal for a product of the same brand,
whereby the database for storing the one or more product information is accessible remotely by the first and the one or more other users under an authorization control of the portal,
wherein a registered user of the portal obtains one or more of respective warranty details or repair history.

35. The system as claimed in claim 34, wherein the product information include one or more of a brand name, model name, model number, date of manufacture, place of manufacture or the warranty details.

36. The system as claimed in claim 34, wherein the identification information include one or more of a serial number, stock keeping unit (SKU) number, International Mobile Equipment Identity (IMEI) number, Universal Product Code (UPC), Electronics Product Code (EPC), European Article Number (EAN) or other manufacturing identification number.

37. The system as claimed in claim 34, wherein the users of the portal include manufacturer, distributor, service center, retailer, consumers/end users, recyclers, logistics providers and insurance providers.

38. The system as claimed in claim 34, wherein a plurality of authentication information are allocated by the portal to a manufacturer, distributor, service center or retailer for accessing information of one or more brands.

39. The system as claimed in claim 34, wherein one or more of the plurality of allocated authentication information obtained by a manufacturer, distributor, service center or retailer is donated to other manufacturer, distributor, service center or retailer.

40. The system as claimed in claim 34, wherein the authentication information includes a unique user ID and password.

41. The system as claimed in claim 34, wherein when a manufacturer of one or more brands registers into the portal, information for each product and/or brand is uploaded, entered, altered or routed in to the database, which is shared by one or more distributors, service centers, retailers or consumers that have registered with the portal.

42. The system as claimed in claim 34, wherein when a distributor of one or more brands registers into the portal, information for each product and/or brand is uploaded, entered, altered or routed in to the database, which is shared by one or more manufacturers, service centers, retailers or consumers that have registered with the portal.

43. The system as claimed in claim 34, wherein when a service center of one or more brands registers into the portal, information for each product and/or brand is uploaded, entered, altered or routed in to the database, which is shared by one or more manufacturers, distributors, retailers or consumers that have registered with the portal.

44. The system as claimed in claim 34, wherein when a retailer of one or more brands registers into the portal, information for each product and/or brand is uploaded, entered, altered or routed in to the database, which is shared by one or more manufacturers, distributors, service centers or consumers that have registered with the portal.

45. The system as claimed in claim 34, wherein when a consumer of one or more brands registers into the portal, information for each product and/or brand is uploaded, entered, altered or routed in to the database, which is shared by one or more manufacturers, distributors, service centers or retailers that have registered with the portal.

46. The system as claimed in claim 34, wherein a registered manufacturer, distributor, service center or retailer obtain one or more region-wise, country-wise, distributor-wise, service center-wise, retailer-wise, product-wise, model-wise or customer-wise information about the failure rate, inventory status, failure details, return rates, etc., based on previously uploaded, entered, updated or routed information of various products handled by other registered users of the portal

47. The system as claimed in claim 34, wherein a registered user of the portal obtains one or more of respective authorized and other service centers, recycling centers, authorized retailers or promotions related to the brand of products.

48. The system as claimed in claim 34, wherein a registered user of the portal uses the portal to extend the warranty, arrange for recycling services, purchase short-term insurance policies, obtain information on when to send and receive a product for repair, receive and approve the quotations from service centers, provide feedback about repairs, or place a request to send a repaired product by a courier.

49. The system as claimed in claim 34, the portal is used to track inflow and outflow in reverse logistics among the registered manufacturers, distributors, service centers, retailers and/or end users/consumers.

50. The system as claimed in claim 49, wherein registered end users/consumers use the portal to track asset value, warranty services of their products.

51. The system as claimed in claim 34, wherein when a manufacturer of one or more brands has not registered with the portal, one or more of distributors, service centers, retailers or consumers that have registered with the portal for the same product operate in a standalone mode, wherein information specific to the products handled by the respective distributors, service centers, retailers or consumers is shared.

52. The system as claimed in claim 51, wherein the information shared in standalone mode include warranty details or repair history related to the specific products handled by the respective distributors, service centers, retailers or consumers.

53. The system as claimed in claim 34, wherein when a recycler, logistics provider or insurance provider registers into the portal, information for any and all products and brands are routed to the recycler's, logistics provider's or insurance provider's account by other users that have registered with the portal.

54. A method for managing product information of one or more brands comprising the steps of:
accessing, by a first user, a portal having a database;
registering and obtaining, by the first user, a first authentication information from the portal;
using the first authentication information to login to the portal;
entering one or more product information including identification information of one or more products of a brand into the database of the portal; and
accessing the stored product information, by one or more other users having respective authentication information obtained after registering with the portal for a product of the same brand,
whereby the database for storing the one or more product information is accessible remotely by the first and the one or more other users under an authorization control of the portal,
wherein a registered user of the portal obtains one or more of respective warranty details or repair history.

55. The method as claimed in claim 54, wherein the users of the portal include manufacturers, distributors, service centers, retailers, consumers/end users, recyclers, logistics providers and insurance providers.

56. The method as claimed in claim 54, wherein the authentication information includes a unique user ID and password.

57. The method as claimed in claim 54, wherein when a manufacturer of one brand registers into the portal, information for each product and/or brand is uploaded, entered, altered or routed in to the database, which may be shared by one or more of distributors, service centers, retailers, consumers/end users, recyclers, logistics providers or insurance providers that have registered with the portal for the same product and brand.

58. The method as claimed in claim 54, wherein when a manufacturer of one brand has not registered with the portal, one or more of the distributors, service centers, retailers, consumers/end users, recyclers, logistics providers and insurance providers that have registered with the portal for the same product may operate in a standalone mode, wherein information specific to the products handled by the respective distributors, service centers, retailers consumers/end users, recyclers, logistics providers or insurance providers is shared.

59. The method as claimed in claim 54, wherein when a distributor of one brand has not registered with the portal, one or more of the manufacturers, service centers, retailers, consumers/end users, recyclers, logistics providers or insurance providers that have registered with the portal for the same product operate in a standalone mode, wherein information specific to the products handled by the respective manufacturers, service centers, retailers, consumers/end users, recyclers, logistics providers or insurance providers is shared.

60. The method as claimed in claim 54, wherein when a service center of one brand has not registered with the portal, one or more of the manufacturers, distributors, retailers, consumers/end users, recyclers, logistics providers or insurance providers that have registered with the portal for the same product operate in a standalone mode, wherein information specific to the products handled by the respective manufacturers, distributors, retailers, consumers/end users, recyclers, logistics providers or insurance providers is shared.

61. The method as claimed in claim 54, wherein when a retailer of one brand has not registered with the portal, one or more of the manufacturers, distributors, service centers, consumers/end users, recyclers, logistics providers or insurance providers that have registered with the portal for the same product operate in a standalone mode, wherein information specific to the products handled by the respective manufacturers, distributors, service centers, consumers/end users, recyclers, logistics providers or insurance providers is shared.

62. The method as claimed in claim 54, wherein a previously unregistered partner registers with the portal, the information available to existing registered partners on standalone mode is available to the newly registered partner.

63. The method as claimed in claim 54, wherein a registered user of the portal obtains one or more of respective authorized and other service centers, recycling centers, authorized retailers or promotions related to the brand of products.

64. The method as claimed in claim 54, wherein a registered user of the portal uses the portal to extend the warranty, arrange for recycling services, purchase short-term insurance policies, obtain information on when to send and receive a product for repair, receive and approve the quotations from service centers, provide feedback about repairs, or place a request to send a repaired product by a courier.

65. The method as claimed in claim 54, wherein a registered user of the portal uses the portal to contact consumers/end users of its products via targeted e-mail and SMS services, using purchase and contact-information contained in the portal.

66. A data storage medium comprising computer code means for instructing a computer to execute a method for managing product information of one or more brands comprising the steps of:
accessing, by a first user, a portal having a database;
registering and obtaining, by the first user, a first authentication information from the portal;
using the first authentication information to login to the portal;
entering one or more product information including identification information of one or more products of a brand into the database of the portal; and
accessing the stored product information, by one or more other users having respective authentication information obtained after registering with the portal for a product of the same brand,
whereby the database for storing the one or more product information is accessible remotely by the one or more other users under an authorization control of the portal,
wherein a registered user of the portal obtains one or more of respective warranty details or repair history.
